(19) United States
(12) Patent Application Publication
(10) Pub. No.: US 2003/0158811 A1
(43) Pub. Date: Aug. 21, 2003

(54) System and method for rules based electronic funds transaction processing

(75) Inventors: Christopher Sanders, San Antonio, TX (US); David Nichol, San Antonio, TX (US); Christopher Dereadt, Schertz, TX (US); Timothy Symchych, San Antonio, TX (US); Joshua Lockwood, San Antonio, TX (US); Yebin Wang, San Antonio, TX (US); Robert Scheibler, San Antonio, TX (US); David Pfiffner, San Antonio, TX (US); Pat Quiroz, San Antonio, TX (US); Simon Bradwell, San Antonio, TX (US)

Correspondence Address: Todd Mattingly, Haynes and Boone, L.L.P., Suite 4300, 1000 Louisiana, Houston, TX, 77002-5012, US

(73) Assignee: Ventanex, San Antonio, TX

(21) Appl. No.: 10/198,292

(22) Filed: Jul. 18, 2002

Related U.S. Application Data
(60) Provisional application No. 60/306,173, filed on Jul. 18, 2001.

(51) Int. Cl. G06F 17/60

(52) U.S. Cl. 705/39; 705/34

(57) ABSTRACT

A system for rules based electronic funds transaction processing includes a business layer configured to receive electronic funds transaction data from a source. The business layer processes the electronic funds transaction data according to at least one of multiple independent rules based processing rules including at least one rule configured to process clearinghouse network dishonored items. A file transfer agent is operatively connected to the business layer for initiating a request to build a data file from the processed electronic funds transaction data. In response to building the data file, the file transfer agent operates to transfer the data file to at least one of a financial institution, an agent of a financial institution, and an electronic funds transaction clearinghouse network for placement of the data file on the electronic funds transaction clearinghouse network. The data file includes a network ready data file having a format at least in accordance with requirements of the electronic funds transaction clearinghouse network. A method and computer software are also disclosed.

This application claims the benefit of the earlier filed provisional application Serial No. 60/306,173, filed Jul. 18, 2001.

### BACKGROUND

The present disclosure relates to financial transaction processing, and more particularly, to a method and apparatus for rules based electronic funds transaction processing, returns processing, and integration.

Financial transaction processing networks provide processing and delivery systems that administer the distribution and settlement of electronic credits and debits among financial institutions (FIs). One example of such a network is the Automated Clearing House Network (ACH Network). Other financial transaction processing networks are also contemplated.

In the United States, the ACH Network is a nationwide automated funds transfer system, governed by the rules of the National Automated Clearing House Association (NACHA). NACHA facilitates the development of operating rules and standards for the ACH Network and for electronic payments in the areas of Internet commerce, electronic bill payment and presentment (EBPP), financial electronic data interchange (EDI), Lockbox (ARC), non sufficient funds (NSF) recovery, electronic checks, electronic benefits transfer (EBT), and student lending, for example.

The ACH Network provides for the inter bank clearing of electronic entries for participating financial institutions. Financial institutions can transmit or receive ACH entries through ACH operators such as the American Clearing House Association, the Federal Reserve, the Electronic Payments Network, and Visa.

Presently, the ACH system uses batch-processing, store and forwarding operations. Batch processing provides quicker, more economical processing than is possible with a realtime online, single transaction process. Accordingly, ACH payments are not processed individually. Instead, the ACH Network leverages the banking industry's current batch workflow competencies.

For processing of financial transactions via the ACH Network, Originating Depository Financial Institutions (ODFIs) submit ACH payment files to the ACH Operators. The ACH Operators accumulate the ACH payment files, sort the payment files by destination, and transmit the sorted files to Receiving Depository Financial Institutions (RDFIs) for application to customer's accounts at predetermined times throughout a business day. Accordingly, the ACH system provides significant economies of scale compared to individual wire transfers, and is faster and more accurate than paper check processing.

ACH transactions are typically categorized as either consumer payments or corporate payments, depending upon the relationship of the parties involved in the transaction and the type of Receiver account. Consumer payments made via the ACH Network can include credit applications, such as, payroll, retirement, dividend, interest, and annuity payments, in addition to educational benefit reimbursements, payments and advances, and many others. Consumer ACH debit applications can include, among others, the collection of insurance premiums, mortgage and rent payments, utility payments, installment payments, a variety of membership dues, and other recurring obligations.

Corporate ACH transactions include cash concentration and disbursement, corporate trade payments, state and Federal tax payments, and financial electronic data interchange (EDI), such as, employer withheld child support payments, among others. Cash concentration and disbursement allows companies to achieve efficiencies in cash management through timely intra-company transfer of funds. Corporate trade payments enable corporations to exchange both data and funds with trading partners, facilitating an automated process of updating their accounts receivable and accounts payable systems.

The ACH Network supports a variety of payment applications. An Originator initiating entries into the ACH system codes the entries in such a manner as to indicate the type of payment, such as, a debit or credit, to the Receiver and whether an entry is consumer or corporate in nature. The funds transfer affects either a consumer account or a corporate account at the RDFI. Each ACH application is identified and recognized by a specific three-digit code, referred to as a Standard Entry Class Code (SEC code), which appears in the ACH record format. The SEC code identifies the specific computer record format that will be used to carry the payment and payment-related information relevant to the application. SEC codes include, but are not limited to: WEB—Internet; TEL—telephone; POP—Point of Purchase; RCK—Re-presented Check; and ARC—Accounts Receivable Entries or Lockbox, for example.

In other words, every transaction on ACH must have an origin type. The origin type describes how the transaction was originated, and more particularly, with respect to its authorization. The NACHA rules that are applied to a given transaction are a function of the transaction origin type. Application of a particular NACHA rule is carried out in order to warrant that the transaction met the corresponding NACHA rule criteria.

For the ACH Network, which follows the NACHA rules, origin types can include Point of Purchase (POP), Re-presentment of Check (RCK), Prearranged Payment or Deposit (PPD), Internet initiated entry (WEB), Telephone debit (TEL), and lockbox (ARC). POP represents remote conversion of a check to an electronic payment at a point of purchase. WEB represents origination of an electronic payment via the Internet. TEL represents the origination of an electronic payment drawn on a checking or debit account via telephone. ARC represents a central conversion of paper checks at a lockbox to electronic payments.

A problem for the various origin types is that a number of different companies (or merchants) can use a corresponding number of different software applications for reporting purposes, such as for reconciliation of the payment transaction with the company's (or merchant's) general ledger. Accordingly, unique solutions to financial network transaction payment processing are required for each company (or merchant). In addition, multiple different applications makes reporting reconciliation transaction management cumbersome.

With respect to back-end systems, such as A/R applications, reconciliation requires getting transaction data into the application of the back-end system for processing. For front-end systems, transaction originations require acquisition of payment information, and may involve a number of different applications.

With respect to the ACH Network, payments are electronic, and batched. With batch processing of electronic payment transactions such as via the ACH Network, a certain number of original transactions are subject to fail. Failure of the electronic payment transaction at the ACH Network may have been caused due to non sufficient funds NSF, invalid bank number, incorrect account number, or any number of other reasons particular to the electronic funds payment processing financial network.

For a plurality of clients, it is possible for each client to have a custom client format for sending transaction data to a payment processor. The format must include, at a minimum, the NACHA required fields or components of a transaction.

Overall, the ACH Network provides an efficient alternative to traditional paper check processing. That is, the ACH Network uses electronic and telecommunications technology to replace paper check processing. However, improved methods for inputting electronic funds transaction data into the ACH Network, as well as, improved methods for handling returns processing are desired.

### SUMMARY

According to one embodiment, a system for rules based electronic funds transaction processing includes a business layer configured to receive electronic funds transaction data from a source. The business layer processes the electronic funds transaction data according to at least one of multiple independent rules based processing rules including at least one rule configured to process clearinghouse network dishonored items. A file transfer agent is operatively connected to the business layer for initiating a request to build a data file from the processed electronic funds transaction data. In response to building the data file, the file transfer agent operates to transfer the data file to at least one of a financial institution, an agent of a financial institution, and an electronic funds transaction clearinghouse network for placement of the data file on the electronic funds transaction clearinghouse network. The data file includes a network ready data file having a format at least in accordance with requirements of the electronic funds transaction clearinghouse network.

### BRIEF DESCRIPTION OF THE DRAWINGS

FIG. 1 is a block diagram view of the system for rules based electronic funds transaction processing according to an embodiment of the present disclosure;

FIG. 2 is a block diagram view of the system for rules based electronic funds transaction processing of FIG. 1 in further detail, according to an embodiment;

FIG. 3 is a functional diagram view of various modules and tiers of the system of FIG. 2 according to an embodiment of the present disclosure;

FIG. 4 is table diagram view of various tables defined for the system of the present disclosure, according to one embodiment;

FIG. 5 is a table diagram view of a transaction file and a modified transaction file according to one embodiment of the present disclosure;

FIG. 6. is a flow diagram view of a dishonored items processing (returns processing) according to one embodiment of the present disclosure;

FIG. 7. is a flow diagram view of one illustrative example for electronic funds processing according to one embodiment of the present disclosure;

FIG. 8 is a partial screen view of a display screen for enabling selection of a custom configured dishonored items processing rule according to one embodiment;

FIG. 9 shows a block diagram view of an integrated rules based electronic funds transaction processing system according to one embodiment;

FIG. 10 is a block diagram view of a system for rules based electronic funds transaction processing according to another embodiment; and

FIG. 11 is a flow diagram view of an accounts receivable conversion work flow according to one embodiment of the present disclosure.

### DETAILED DESCRIPTION

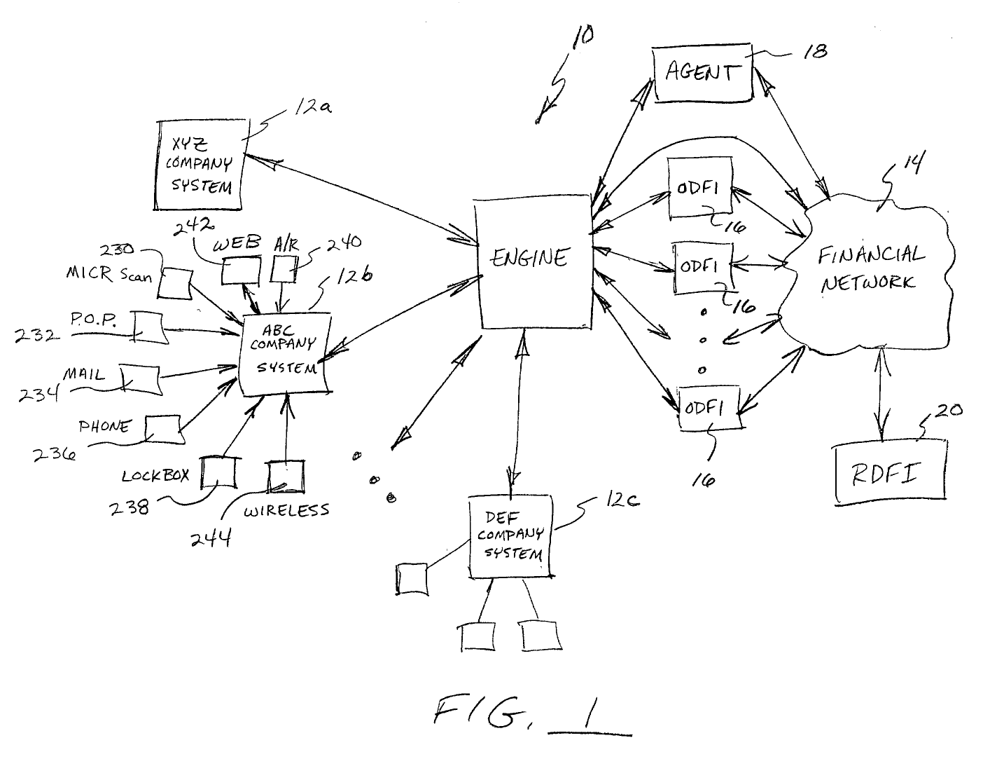

Referring to FIG. 1, a block diagram view of a system for rules based electronic funds transaction processing according to an embodiment of the present disclosure shall now be discussed. The system of FIG. 1, generally indicated by the reference numeral 10, includes an computer system engine configured for interfacing between a source, such as one or more of company systems 12a, 12b, 12c (e.g., XYZ, ABC, DEF, etc.) and a financial network 14. The system engine 10 is operatively connected to at least one of a financial institution (ODFI) 16, an agent of a financial institution (AGENT) 18, and an electronic funds transaction clearinghouse network (FINANCIAL NETWORK) 14. Further as shown in FIG. 1, the financial network 14 is operatively connected to a receiving depository financial institution (RDFI) 20.

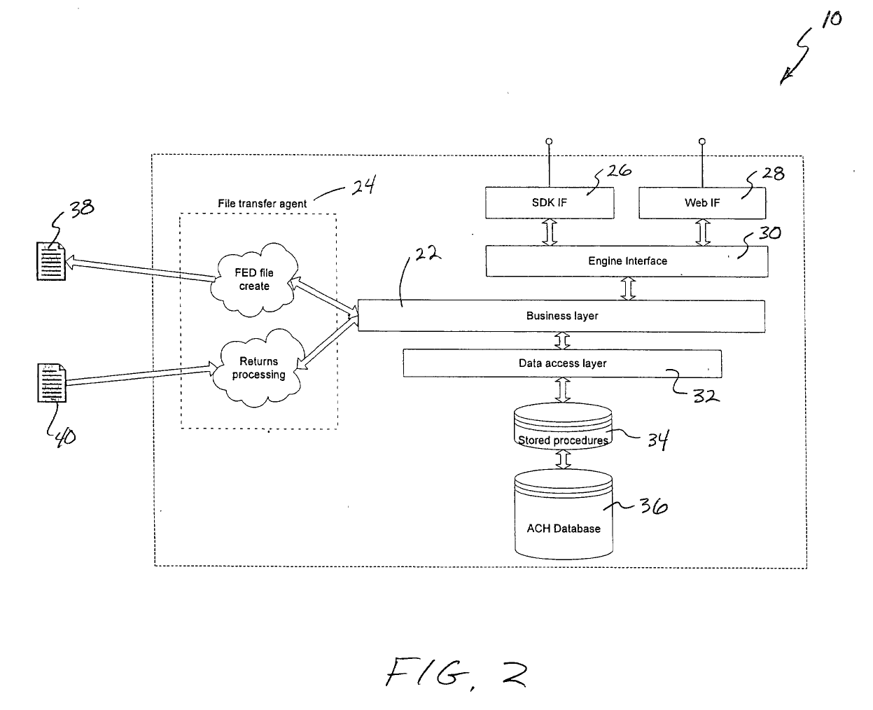

Turning now to FIG. 2 and as will be discussed further herein, the system engine 10 includes a business layer 22 operatively connected to a file transfer agent 24. The system engine further includes an engine interface operatively coupled to the business layer. One or more software developer kit interface (SDK IF) 26 and/or web interface (Web IF) 28 are operatively coupled to the engine interface 30. Operatively coupled to the business layer 22 is a data access layer 32, the data access layer 32 further being operatively coupled to a stored procedures database 34 and further coupled to a financial electronic funds clearinghouse network database (ACH Database) 36. As will be discussed further herein, the file transfer agent 24 is configured to create and output a network ready data file (e.g., a FED file) 38. The file transfer agent is further configured to receive a returns processing file 40 for returns processing (dishonored items processing), also further as discussed herein.

Referring to FIGS. 1 and 2, the system for rules based electronic funds transaction processing 10 includes a business layer 22 and a file transfer agent 24. The business layer 22 is configured to receive electronic funds transaction data from a source (12a, 12b, 12c) and to process the electronic funds transaction data according to at least one of multiple independent rules based processing rules. The independent rules based processing rules include at least one rule configured to process electronic funds clearinghouse network dishonored items. In addition, in one embodiment, at least one rule may be configured to process electronic funds clearing house network dishonored items on a case by case basis. As discussed herein, a electronic funds clearing house network dishonored item includes an electronic funds transaction item returned from the electronic funds clearing house network 14 as a failed item, not acceptable for processing as determined by the electronic funds clearing house network.

The file transfer agent 24 operatively connects to the business layer 22 for initiating a request to build a data file from processed electronic funds transaction data. In response to building the data file, the file transfer agent 24 transfers the data file 38 to at least one of a financial institution 16, an agent of a financial institution 18, and an electronic funds transaction clearinghouse network 14. The file transfer agent 24 transfers the data file 38 for placement of the data file on the electronic funds transaction clearinghouse network 14.

The data file 38 includes a network ready data file having a format at least in accordance with requirements of the electronic funds transaction clearinghouse network 14. For example, in one embodiment in which the electronic funds transaction clearinghouse network includes the ACH Network, the data file comprises an ACH-Ready batch file.

In another embodiment, one of the multiple independent rules based processing rules includes a custom configured business rule. For example, a biller may comprise the source 12a of electronic funds transaction data to the electronic funds transaction processing system 10. The electronic funds transaction data includes the biller's electronic funds transaction items. In such an instance, the custom configured business rule may include a rule to prevent submission of a transaction item to the electronic funds transaction clearinghouse network if the transaction item contains a transaction amount for less than a transaction amount owed. The biller may include a mortgage company or other entity. In the case of a mortgage company, the system 10 enables the biller to process the electronic funds transaction items via a custom configured business rule prior to the particular items being submitted to the electronic funds transaction clearinghouse network 14. Additional types of custom configured business rules are contemplated, the custom configured business rules being configured according to the particular requirement of a respective source (12a, 12b, 12c) of electronic funds transaction data.

The system 10 further comprises an interface (26, 28, 30). The interface (26, 28, 30) is configured to import the electronic funds transaction data from the source to the business layer 22. In addition, source credentials identify the source (12a, 12b, 12c). Interface credentials identify the interface. At least one of the multiple independent rules based processing rules further includes a verification rule. The verification rule is configured to prevent processing of the received electronic funds transaction data if either one or both of the source credentials and interface credentials is invalid.

The interface 30 may also be configured to receive a request from the source (12a, 12b, 12c) in connection with electronic funds transaction data. Upon receiving a request via the interface, the business layer 22 processes the request and provides a response to the source (12a, 12b, 12c) via the interface 30.

In one embodiment, the system 10 includes an engine interface (ACH_IF) component 30. The engine interface (ACH_IF) component 30 exposes outside systems (i.e., external systems) to the system engine of the present disclosures. Accordingly, the interface component 30 provides a single entry point to the system engine, thus reducing the chances of unauthorized or improper use of system components and resources.

Various information is obtained for setting up a source or customer for a) accessing the system engine via the interface and b) using the components and resources of the system engine. The information can include, but not be limited to, a company name to be used in the network ready data file (e.g., FED file); the ABA of the source's settlement account; the account number of the settlement account (i.e., a business account); the identification of which bank to route the transactions through; transaction entry description for use in the network ready data file; and email address of where to send information concerning ACH related material such as to an administrator who will administer rights to the system engine. In response, the source (or customer) is provided with a username and password, corresponding to the source (or customer) credentials.

The system 10 further comprises a database layer 32. The database layer 32 is operatively connected to the business layer 22. The business layer 22 and the database layer 32 are configured to perform suitable actions in response to one or more of (a) a client source configured query, (b) a client source configured request, and (c) a hosting system query. The business layer 22 is further configured to receive the client source configured query and the client source configured request via an interface, such as an SDK interface 26 or Web interface 28. The client source configured query may include a transaction history query, for example. In addition, the client source configured request may include a transaction creation request, a recurring transaction modification request, or other request.

In another embodiment, the system 10 is configured to host the processing of electronic funds transaction data from multiple sources (12a, 12b, 12c). As a hosting system, the multiple independent rules based processing rules can further include a hosting system business rule. With respect to a hosting system business rule or query, the business layer 22 may further be operatively connected to a Positive/Negative database. In such an instance, the hosting system query may include configuring the business layer 22 to process the electronic funds transaction data as a function of Positive/Negative data in the Positive/Negative database.

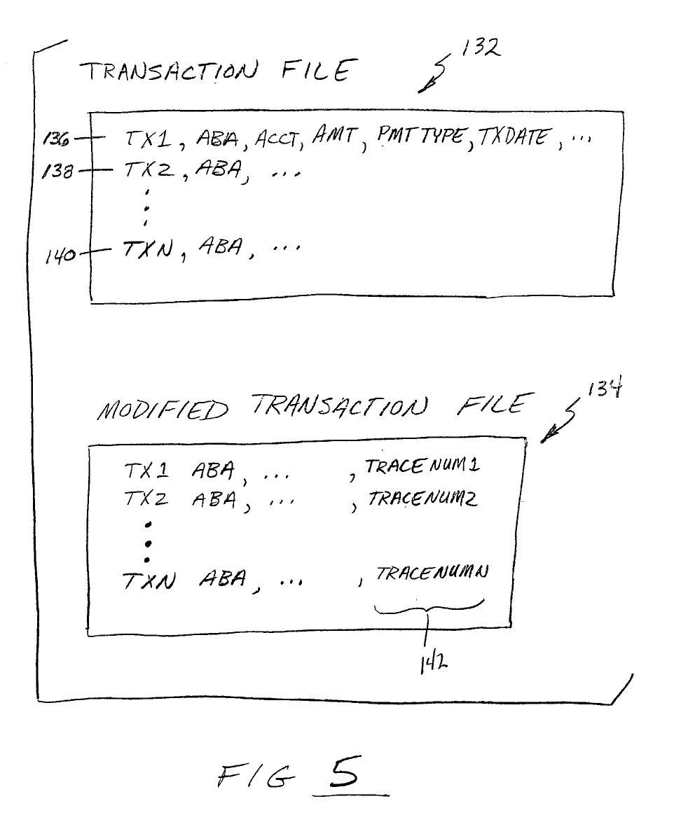

Prior to transferring of the network ready data file 38 to at least one of the financial institution 16, the agent of the financial institution 18, and the electronic funds transaction clearinghouse network 14, the business layer 22 assigns a transaction trace number to each transaction item of the processed electronic funds transaction data, as will be discussed further in connection to FIG. 5. The transaction trace number enables tracking of a corresponding transaction item during dishonored items processing of a dishonored items data file retrieved from one or more of the financial institution 16, the agent of the financial institution 18, and the electronic funds transaction clearinghouse network 14.

According to one embodiment, the transaction trace number includes at least one selected from the group consisting of a number based upon an algorithm, a sequence number based upon prior transaction processing, and a concatenation of a financial institution identification number with a current trace number. In the later instance, the current trace number represents a number for use with a next transaction item in a series of transaction items.

The file transfer agent 24 retrieves dishonored item data 40 from the at least one of the financial institution 16, the agent of the financial institution 18, and the electronic funds transactions clearinghouse network 14.

In response to the dishonored item data retrieved by the file transfer agent 24, the business layer 22 processes the dishonored item data according to one or more of the following: (a) a rules based processing rule and (b) an electronic funds transaction clearinghouse network rule. For example, the rules base processing rule may include a custom configured business rule. Similarly, the electronic funds transaction clearinghouse network rule may include an electronic funds transaction clearinghouse network dishonored items rule.

As mentioned herein above, the system 10 further comprises a database layer 32 and a database storage (34, 36). The database layer 32 operatively connects to the database storage (34, 36). In one embodiment, the database storage 36 stores the transaction trace numbers assigned by the business layer 22 with corresponding transaction data of the processed electronic funds transaction data. In addition, the business layer 22 performs data manipulation of the processed electronic funds transaction data according to (a) dishonored transaction items processing rules and (b) a tracking of dishonored transaction items via respective transaction trace numbers.

The database layer 32 stores information in the database storage 36 for tracking dishonored transaction items. For example, in one embodiment, the information for tracking dishonored transaction items includes initial transaction trace numbers corresponding to trace numbers of transaction items prior to respective ones of the transaction items becoming dishonored transaction items. The information for tracking dishonored transaction items also includes subsequent transaction trace numbers corresponding to trace numbers of dishonored transaction items prior to respective ones of the dishonored transaction items becoming subsequent dishonored transaction items.

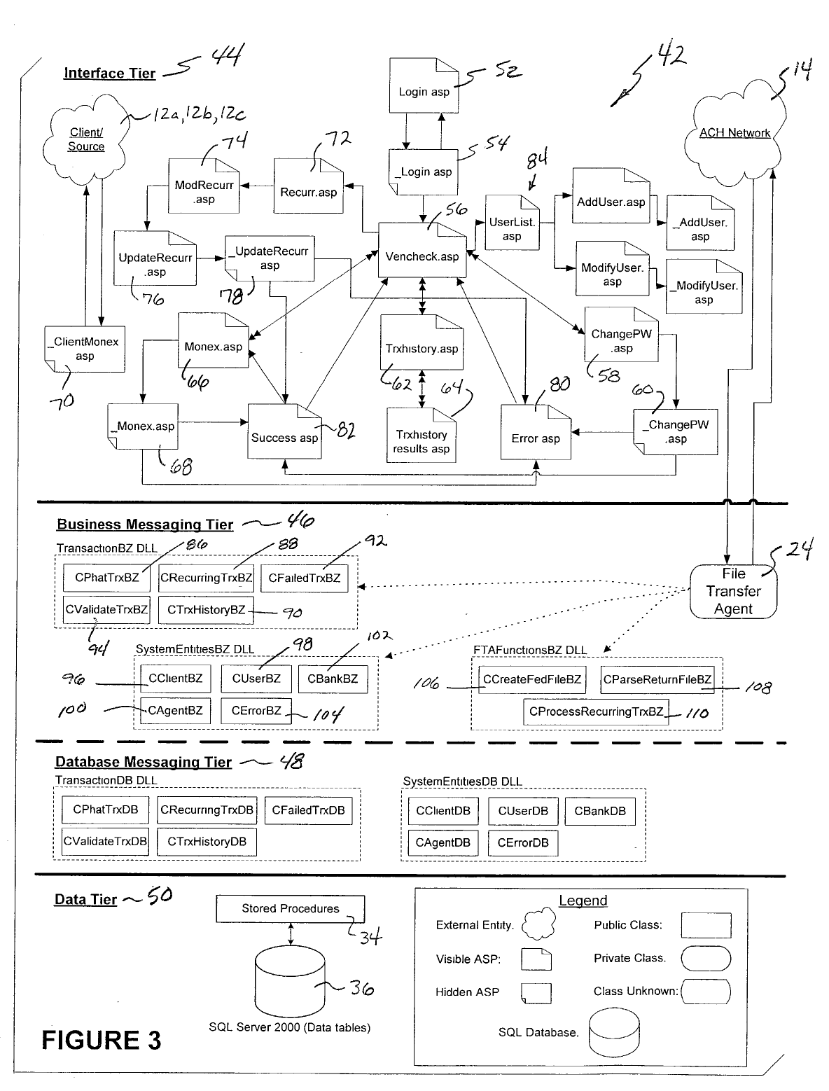

FIG. 3 illustrates a functional diagram view 42 of various modules and tiers of the system 10 of FIG. 2 according to an embodiment of the present disclosure. The system includes an interface tier 44, a business messaging tier 46, a database messaging tier 48, and a data tier 50.

In one embodiment as shown in FIG. 3, the system operates with the following assumptions: the ACH Network 14 returns unique codes for successful transactions; the ACH Network 14 returns unique codes for failed transactions with varying codes for different failure reasons; the system connects to the ACH Network 14 via the Internet (FTPS); and a reconciliation manager of the system utilizes Microsoft Internet Explorer (MS IE) 4.0 or later.

Technology/Tools applicable for use in programming of the present embodiments include: Microsoft Visual Studio 6.0 for software development; Visual Basic for COM development; Visual Interdev for ASP development; Microsoft SQL 7 and “stored procedures” for the database; IIS 4.0 for Web delivery; HTTPS and FTPS 128 bit encryption for secure transactions (using a key obtained from Verisign); Severs @ Exodus for physically secure servers (Caged, limited access); ADO for passing data between parts of the system; COM+ to make the system modular and scalable; and Java Script 1.1 for Browser/Client validation.

Main software modules include a validation module, a transaction module, a recurring payment module, a reconciliation interface module, a client interface module (“monex.asp”), a primary database, and a secondary database (for archived transactions)

According to one embodiment, the tiers of FIG. 3 can include various active server pages (.asp). When a browser requests an .asp page, the web server generates a page with HTML code and sends it back to the browser. The functionalities are as follows:

Web Tier (Interface Tier) 44:

Global.asp:

Create CID (Session variable) after Login

Create GbIn_ValidUser (Session Variable) after Login

Set Session variables to null on session end

Update fldlnuse to false on session end.

Login.asp 52:

Validate values—JavaScript

Call_Login.asp (Post Username and Password)

Notify Client of failed Login attempt (if failed attempt occurred)

_Login.asp 54:

Request Posted information from Login.asp

Call Validation Module

Receive CID from Validation Module (if validated)

Validated login will update fldInuse in tblClient to TRUE

Redirect to Login.asp (if not validated)

Redirect to VenCheck.asp

LoggedOut.asp:

Notifies user their session has expired or they have logged off.

VenCheck.asp 56:

Menu page: requires bi-directional functionality to/from (call or return) ChangePW.asp, TrxHistory.asp, and Monex.asp.

ChangePW.asp 58:

Allow Client to change existing password.

Validate values—JavaScript

Call_ChangePW.asp (Post Old and New Interface Userpassword)

_ChangePW.asp 60:

Request posted information from ChangePW.asp

Call CupdatePasswordBz in business object

Call Success.asp (if validated)

Redirect to ChangePW.asp and display error message (if not validated)

TrxHistory.asp 62:

Client Interface that is searchable by the following criteria:

Date Range

Individual Name

Account Number

Payment Type (Single or Recurring)

Transaction Code

Description

Types of Transactions

1. All Transactions

2. Successful Transactions

3. Failed Transactions

4. Pending(Queued) Transactions

Javascript Validation—Date range and Amount field are required

Posts to TrxHistoryResults.asp

TrxHistoryResults.asp 64:

Request data from TrxHistory.asp

Call CtransactionHistoryBZ (submit criteria) in business layer

CtransactionHistoryBZ calls on CfetchDB in the DB layer to perform one of the following functions:

FetchAllTransactionByCriteria

FetchTransactionByCriteria

Fetch FailedTransactionByCriteria

FetchQueuedTransactionByCriteria

CfetchDB receives data from one of the following tables or all three through use of stored procedures:

tblClient

tblFailedTransactions

tblQueuedTransactions

CfetchDB sends data back to CtransactionHistoryBZ

TrxHistoryResults displays all transactions according to submitted criteria

Ability to credit transactions

Monex.asp 66:

Interface for single transaction information (i.e. ABA number, DFI Account, etc . . . )

Validate values—JavaScript

Call_Monex.asp (Post transaction information)

_Monex.asp 68:

Request posted information from Monex.asp

Call CTransactionBz (submit transaction information)

Redirect to Success.asp (if validated or transacted)

Redirect to Error.asp (if not validated or not transacted)

_ClientMonex.asp 70:

Accept SOAP requests

Allow for posted information from other Web Sites

Allow other Web Sites to setup recurring transactions.

Call CtransactionBz if Single transaction

Call CrecurrSetupBz if Recurring transaction

Return query string successful (if validated or transacted)

Return query string containg errors (if not validated or not transacted)

Recurr.asp 72:

Creates Recurring Payments

Javascript validation

ModRecurr.asp 74:

Fetches recurring payments

Fetch by Individual Name or Fetch All

UpdateRecurr.asp 76:

Allows User to update or delete recurring payments.

Javascript validation

_UpdateRecurr.asp 78:

Request posted information from UpdateRecurr.asp

Call CRecurrTrxSetupBz (submit transaction information)

Redirect to Success.asp (if validated or transacted)

Redirect to Error.asp (if not validated or not transacted)

Error.asp 80:

Generic ASP to display errors encountered.

Module will return a string of error codes which will be split here

Errors should follow this standardization

100: Invalid Username/Password

101: Invalid ABA

102: Invalid Amount

103: Invalid Account Number

104: Invalid Date

105: Invalid Payment Type

106: Invalid Transaction Code

107: Customer Name(Individual Name) exceeds allowed length

108: Description exceeds allowed length

109: Invalid Frequency for Recurring Payment

110: Invalid Characters for Length of Recurring Payment

Success.asp 82:

Generic ASP to display successful action

Module will return a string describing successful action.

Additional modules can also be included, for example, in connection with a system user list, adding users and modifying user access, generally indicated by reference numeral 84.

Engine Interface

In one embodiment, the engine interface (e.g., the ACH Interface) includes features as discussed below. At login, a user accesses the VenCheck.asp 56 to review and select an option from the following: View Transaction History; Enter New Transaction; Enter/Edit Recurring Transactions; Change Password; and Sign Out.

View Transaction History

At the TrxHistory.asp 62, a user can search for transactions by entering search criteria. In one embodiment, transactions are searchable for the past 90 days only. While certain fields for the TrxHistory.asp page 62 may not be required, below is an explanation of expectations for various of the fields on this page.

Date Range—If there is not a date ranged entered, the date field is defaulted to the past 90 days.

Individual Name—This refers to the user name on the account.

Account Number—This refers to the user's account number, containing between 1 and 9 characters.

Amount—If there is no data entered in this field, the search will include all amounts from the range of $1 to $9999999.99.

Payment Type—User can search for individual recurring transactions, individual single transactions, or by both. If no records exist for any situation, a message, “No records were found” will appear.

Transaction Code—These codes describe the type of transaction, whether it was a credit, debit, or loan payment.

Description—The details of the transaction.

Business/Personal—User can choose between business accounts and personal accounts. In one embodiment, this field defaults to business.

All Transactions/Successful/Failed/Pending—User can choose which transaction that the user desires to view. In one embodiment, this field defaults to show all transactions.

When a TrxHistory.asp page 62 is submitted, it will then proceed to TrxHistoryResults.asp 64. The TrxHistoryResults.asp page contains a javascript function getValue( ). The getValue( ) function will carry values of the previous page, TrxHistory.asp, in a URL string when the customer changes the number of rows that the customer desires displayed on the page. GetValue( ) will submit the form to _TrxHistory.asp. _TrxHistory.asp gets the RowNum that the user has selected and redirect back to TrxHistoyResults.asp with a new RowNum value and the data from the URL string.

Enter New Transactions

The Monex.asp page 66 is the starting point for entering new transactions. In one embodiment, the fields listed below are required to enter a transaction:

Payable To—Name of person who is receiving the transaction

Amount—Amount of transaction. Can only be numeric entries, otherwise you will get a javascript error, “You must enter only numeric numbers for the transaction amount”. It amount exceeds 9999999.99, you will also receive the error, “the transaction amount is invalid”.

Bank Name—Name of financial institution that the transaction is coming from.

Description—Briefly describes the details of the transactions.

Transaction Type—Either checking debit/credit, savings debit/credit, or loan amount.

Account Type—Designates whether it is a business or personal account.

Routing Number—Number of the bank. Has to be nine numeric characters in length.

Account Number—Range for 1 to 9 numeric characters.

Monex.asp 66 posts the data information to _Monex.asp 68. The transaction and account type are then determined. This page checks against the badABA table for matching ABA numbers. If a badABA exists, and error page will appear with the message, “Your ABA is no longer in use”. If a badABA does not exist, an appropriate function in the CPhatTrxBZ module is called, the data is inserted into database, and user is redirected to Success.asp 82.

Enter/Edit Recurring Transactions

The Recurr.asp page 72 is the starting point for recurring transactions. Similar to Monex.asp 66, the following fields are required to enter a recurring transaction:

Payable To—Name of person who is receiving the transaction

Amount—Amount of transaction, numeric entries only, otherwise you will get a javascript error, “You must enter only numeric numbers for the transaction amount”. If the amount exceeds 9999999.99, you will also receive the error, “the transaction amount is invalid”.

Bank Name—Name of financial institution that the transaction is coming from.

Description—Briefly describes the details of the transactions.

Transaction Type—Either checking debit/credit, savings debit/credit, or loan amount.

Routing Number—Number of the bank. Has to be nine numeric characters in length.

Account Number—Range for 1 to 9 numeric characters.

Payment frequency—Determines when transactions will occur (i.e. weekly, biweekly, monthly, quarterly, semi-annually, or annually).

Length of Time—Tell how many times you want the payment frequency to occur. If field is left blank, user will receive a message, “Please select a transaction frequency”. User must also enter a numeric digit for this field. If data entered is non-numeric, user will receive the message, “Please enter digits only for transaction length”. For instance, if the user chooses weekly with the length of time being 4, the transaction will occur every week for 4 weeks.

The Recurr.asp page 72 posts to _Recur.asp, the transaction type determined, and an appropriate function in the CRecurrTrxBZ module is called. If the return code is “Successful”, then the user is redirected to Success.asp 82. If the return code is not “Successful”, the user is redirected to Error.asp 80 with the error listed.

Change Password

Changing a password starts with the ChangePW.asp page 58. In one embodiment, passwords, old and new, have to be at least 6-15 characters in length. After user changes have been validated, the data is posted to—ChangePW.asp 60. An appropriate function in the CUserBz module is then called. If the return code is “Successful”, then the user is redirected to Success.asp 82. Otherwise, the user is redirected to ChangePW.asp 58 with an indication that the change failed.

Sign Out

A_SignOut.asp page is configured to set all cookies of the session to blank or false value and redirects the user to the _login.asp.

Further with reference to FIG. 3, the tiers relate in the following way. The active server pages (.asp) in the Interface Tier 44 access functionality in the Business Messaging Tier 46 objects. The objects in the Business Messaging Tier 46 access functionality in the Database Messaging Tier objects 48, which in turn access stored procedures that retrieve or manipulate data in the database of the Data Tier 50. In addition, the File Transfer Agent (FTA) 24 also uses the functionality provided by the Business Messaging Tier 46 objects to insert and retrieve data from the database, as well as to hold some of its core functionality.

Business Messaging Tier 46:

The Business Messaging Tier 46 objects are responsible for enforcing business logic, ensuring the integrity of the data before the data reaches the database, enforcing security, and doing most of the computationally complex processes of the various processing functions as discussed herein. The Business Messaging Tier 46 modules are the “workhorses” of the system. A brief overview of the functions of the modules in the Business Messaging Tier follows.

CPhatTrxBZ 86: This module deals with data in a master transaction table, where each transaction that passes through the system maintains a unique ID, or trace number.

CRecurringTrxBZ 88: Deals with data in a recurring transaction table, where a transaction may be scheduled to run multiple times.

CTrxHistoryBZ 90: Allows reporting on transactions.

CFailedTrxBZ 92: Deals with returned transactions.

CValidateTrxBZ 94: Ensures that the transaction data entering the system is valid and appropriate.

CClientBZ 96, CUserBZ 98, CAgentBZ 100, CBankBZ 102: These modules provide functions for deleting, inserting, updating, and validating different system entities in connection with clients, users, agents, and banks, respectively.

CErrorBZ 104: Contains functions dealing with handling system errors.

CCreateFedFileBZ 106: Responsible for creating a file that holds transactional data and is sent to the ACH Network.

CParseReturnFileBZ 108: Reads a file that is received from ACH Network containing data on returned transactions. It also implements with any rules-based return processing.

CProcessRecurringTrxBZ 110: Creates recurring transactions as they are scheduled.

Database Messaging Tier 48:

The Database Messaging Tier 48, in contrast, primarily exists simply to pass data through to the stored procedures 34. Accordingly, the modules in the Database Messaging Tier 48 as shown in FIG. 3 pass data from their counterparts in the Business Messaging Tier 46 to the stored procedures 34, which in turn deal directly with the tables in the database 36 of the Data Tier 50.

Example of Transaction Data Retrieval

To further illustrate the embodiment shown in FIG. 3, let us consider an example of transaction data retrieval in which a user views the Trxhistoryresults.asp page 64. This page displays a list of transactions based on search criteria chosen by the user. The page uses ASP code, such as, code similar to the following:

Set obj=CreateObject(“TransactionBZ.CPhatTrxBZ”)

Set rst=obj.FetchTransactionData([username], [password], [date])

Call Display(rst)

The variable “obj” is a reference to the proper module (that is, TransactionBZ.DLL.CPhatTrxBZ), and “rst” is a container for the data. Accordingly, the page prepares the module, gives the proper function a username, password, and date, and then, having received the data, displays it via the browser. The function that the module calls in CPhatTrxBZ 86 can be similar to the following:

Public Function FetchTransactionData(ByVal Username As String, ByVal Password As String, ByVal SearchDate As Date) As ADODB Recordset

Dim objPhatTrx As ACHTransactionDB.CPhatTrxDB

Dim objUser As ACHSystemEntitiesBZ.CUserBZ

Set objPhatTrx=CreateObject(“ACHTransactionDB.CPhatTrxDB”)

Set objUser=CreateObject(“ACHSytemEntitiesBZ.CUserBZ”)

If objUser.ValidateUser(Username, Password) Then

Set FetchTransactionData=objPhatTrx. FetchTransactionData(Search Date)

Else

ReturnError(“Permission Denied”)

End If

Set objPhatTrx=Nothing

Set objUser=Nothing

End Function

The above code creates objPhatTrx, a reference to the Database Messaging Tier 48 CPhatTrxDB object, and objUser, a reference to the SystemEntitiesBZ.CUserBZ 98 module, which can verify that the username and password are valid. If the module returns false, an error is returned. Otherwise, the module returns the requested data from the corresponding Database Messaging Tier 48 function. The Database Messaging Tier 48 function can be similar to the following:

Public Function FetchTransactionData(ByVal SearchDate As Date) As adodb.Recordset

Dim rst As adodb.Recordset

Dim conn As adodb.Connection

Dim cmd As adodb.Command

Set cmd=New adodb.Command

With cmd

.CommandText=“uspSelTrxByDate”

.CommandType=adCmdStoredProc

.Parameters.Append .Createparameter(“@Search Date”, Search Date)

End With

Set conn=New adodb.Connection

Call conn.Open(“DSN=THEDSN”)

Set cmd.ActiveConnection=conn

Set rst=New adodb.Recordset

rst.CursorLocation=adUseClient

rst.Open cmd

Set rst.ActiveConnection=Nothing

Set FetchTransactionData=rst

conn.Close

Set rst=Nothing

Set cmd=Nothing

set conn=Nothing

End Function

The Database Messaging Tier 48 function uses three utility classes (“rst,” “cmd,” and “conn”), which are tools for dealing with a database. In essence, this function sets up a connection to the database (“conn”), creates a command to give the database (“cmd”), and receives the data (into “rst”), passing the data to the calling function in the Business Messaging Tier 46. Continuing with the above example illustration, the stored procedure 34 can be defined as follows:

CREATE PROCEDURE uspSelTrxByDate

@ SearchDate SMALLDATETIME

AS

BEGIN

SELECT

fldTrxTraceNumber,

fldDescription,

fldABA,

fldAccountNum,

fldAmount,

fldPmtType,

fldTrxDate,

fldIndividualName,

fldOrigin,

fldClientID,

fldStatus,

fldCheckNumber,

FROM

tblTransaction

WHERE

fldTrxDate=@SearchDate

END

GO

The stored procedure 34 returns the listed fields (fldTrxTraceNumber, fldDescription, etc.) from the appropriate data table (tblTransaction), selecting all records that match the date criterion.

As can be readily understood in view of the above discussion, the various tiers allow the system to be modular—so parts of the system can be replaced without replacing the entire system—and scalable. Accordingly, the system can more easily grow in terms of both scale and functionality over the long term, or as necessary for a given system implementation.

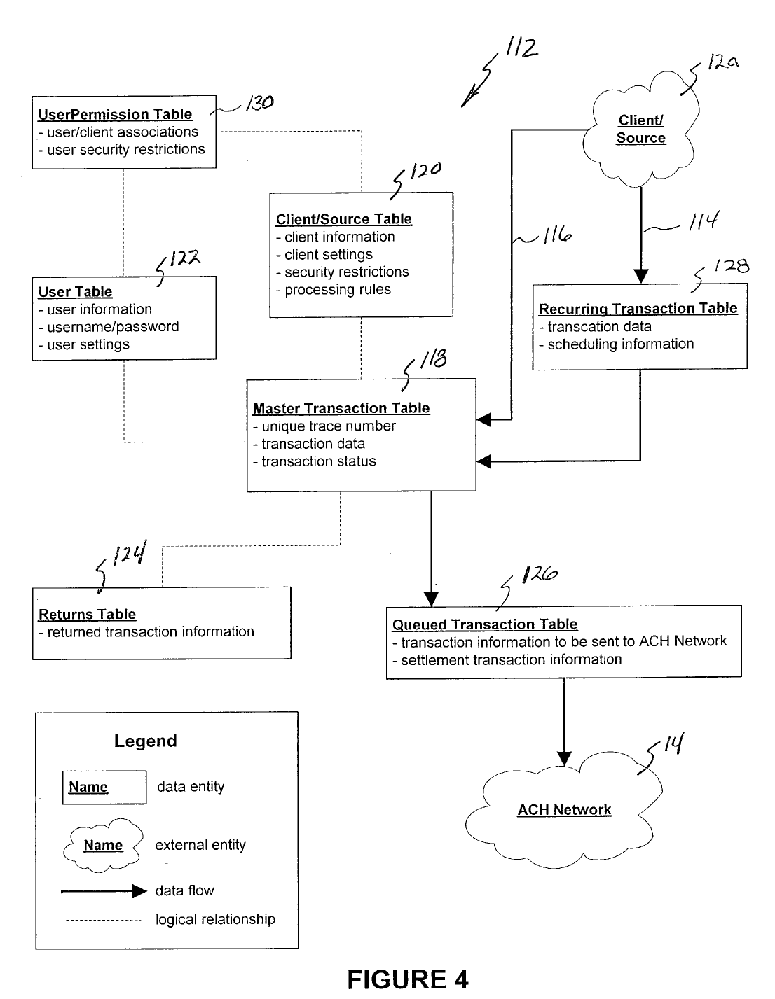

FIG. 4 is table diagram view, generally indicated by reference numeral 112, of various entities, or data tables, as defined according to one embodiment for the system of the present disclosure. The arrows represent data flow. A client/source entity 12a provides transaction data to the system, either as recurring 114 or one-time transactions 116. The Master Transaction Table 118 is a central data entity in the system, also referred to herein as “PhatTrx”. The Master Transaction Table 118 is supported by client/source and user tables (120 and 122, respectively). In addition, a returns table 124 provides return information for any transactions that fail (i.e. the transactions are dishonored). The system places transaction information in the queued transaction table 126, where the transaction information is queued to be sent to the ACH Network 14. Further as shown in FIG. 4, the dashed lines between entities represent logical links (whether one-to-one, or one-to-many) between tables.

Referring still to FIG. 4, the Master Transaction Table 118 holds transactions that have been sent and awaiting either failure notification or a predetermined time limit (e.g., 90 day limit) at which time the transactions are assumed to be successful. The Recurring Transaction Table 128 holds transaction data and scheduling information for recurring transactions on the system engine. The Queued Transaction Table 126 holds transaction information to be sent to the ACH Network 14 for a given processing period (e.g., a day or some other interval of time). The Queued Transaction Table 126 can also hold settlement transaction information. The UserPermission Table 130 stores information pertaining to user/client associations, and user security restrictions. The User Table 122 holds user information, username/password, and user settings pertaining to users of the system. The Client/Source Table 120 stores client/source information pertaining to the clients of the system, in addition to respective client settings, security restrictions, and client configured processing rules. The Returns Table 124 holds returned transaction information.

Turning now to FIG. 5, a diagram view of a transaction file 132 and a modified transaction file 134 according to one embodiment of the present disclosure is shown. In this illustration, a client/source custom transaction file 132 may include a comma separated format of transactions. The transaction data entries may include a listing of “n” number of transactions, listed one transaction per line. A first entry 136 may include: 1, ABA_1, ACCT#_1, AMT_1, Effective Date_1, Account Type_1, Origin_1. The second entry 138 may include: 2, ABA_2, ACCT#_2, AMT_2, Effective Date_2, Account Type_2, Origin_2. The entries follow a similar format, up to the maximum number “n” of entries. The nth entry 140 may include: n, ABA_n, ACCT#_n, AMT_n, Effective Date_n, Account Type_n, Origin_n. If there were 100 transactions in the custom transaction file 132, the system engine of the present embodiments would create and assign 100 unique trace numbers 142, i.e., one each to a corresponding transaction.

In operation, the system engine imports a client/source formatted transaction file 132 for processing. The engine assigns unique trace numbers 142 to each of the transactions of the clientsource formatted transaction file 132 and saves the unique trace numbers with the corresponding transactions into a modified transaction file 134. That is, the modified transaction file 134 includes the transaction data of the client formatted transaction file and corresponding unique trace numbers per transaction of the client formatted transaction file.

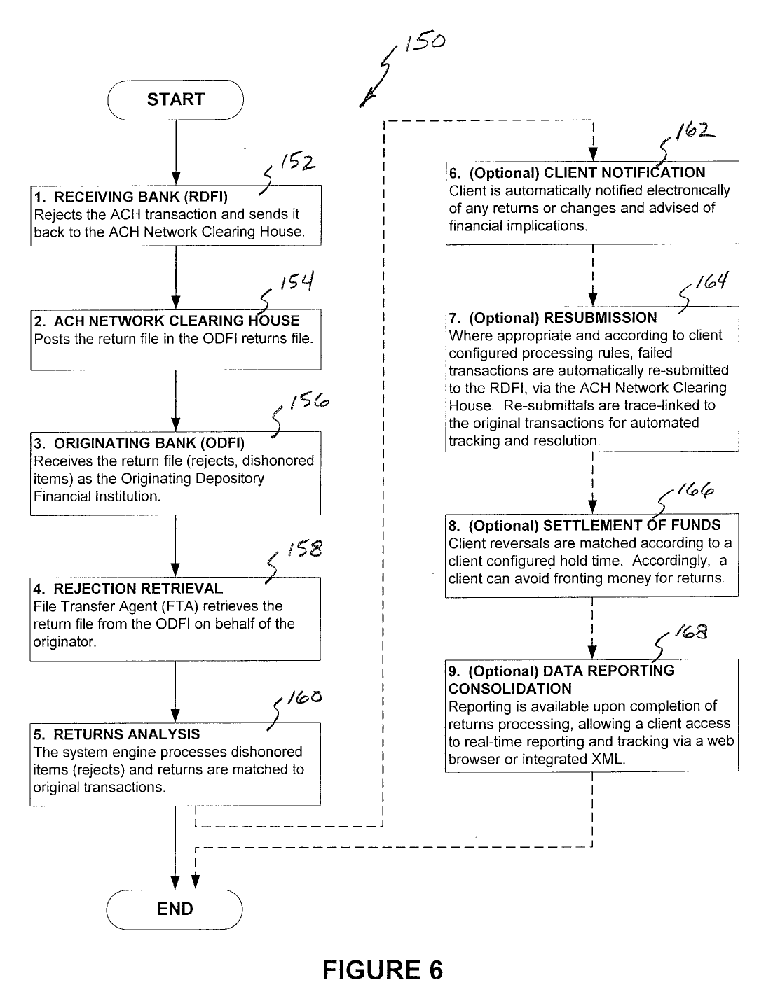

FIG. 6. is a flow diagram view of a dishonored items processing (returns processing) according to one embodiment of the present disclosure, generally indicated by the reference numeral 150. In dishonored items processing, a receiving bank (RDFI) rejects a transaction and sends it back to the electronic funds transaction clearinghouse network (152). The electronic funds transaction clearing house network posts the return file in the ODFI returns file (154). The originating bank (ODFI) receives the dishonored items file (returns or rejects) as the Originating Depositor Financial Institution (156). During retrieval of dishonored items (rejection retrieval), the file transfer agent (FTA) retrieves the dishonored items file (rejects file) from the ODFI on behalf of the originator (158). During a dishonored items processing (returns analysis), dishonored items are matched to original transactions (160), further as discussed herein.

In one embodiment, during a client notification (162), a client is automatically notified electronically of any dishonored items (returns) or changes and advised of financial implications. During a resubmission step (164), where appropriate and according to client specification or financial network resubmission eligibility rules, failed transactions are automatically re-submitted to the RDFI, via the financial network. Re-submittals are trace-linked to the original transactions for automated tracking and resolution. During a settlement of funds (166), and in the event of failed or dishonored items, client reversals are matched according to a hold time according to one embodiment. As a result, a client is not required to front money for returns or dishonored items. Lastly, during a data reporting consolidation (168), immediate reporting is available upon completion of returns processing, allowing the system client access to real-time reporting and tracking via a web browser or integrated XML. As noted in FIG. 6, steps 162-168 are optional, in any combination, for a particular system requirement.

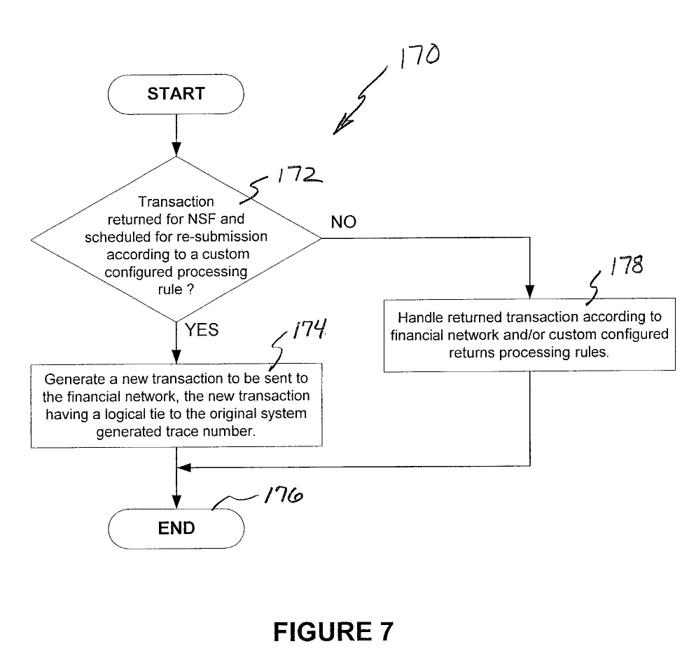

FIG. 7 is a flow diagram view of one illustrative example for electronic funds processing, according to one embodiment of the present disclosure, generally indicated by reference numeral 170. In particular, the flow diagram of FIG. 7 illustrates an example for dishonored items processing (returns processing). In this example, the rules based processing rule includes querying whether the reason for the dishonored item is non-sufficient funds (NSF), and whether the dishonored item is eligible for resubmission (172). If eligible, then a new transaction is generated (174), the new transaction to be sent to the financial network. The new transaction further includes having a logical tie to the original system generated trace number. The process then returns to a calling process (176). If the query (172) resulted in a negative response, then the dishonored item would be handled according to one or more of the financial network and/or custom configured dishonored (returns) processing rules (178). For example, the financial network may only allow a certain number of resubmissions for a transaction item that has been dishonored. The custom configured dishonored processing rule may include providing a notification to the client of the dishonored transaction item.

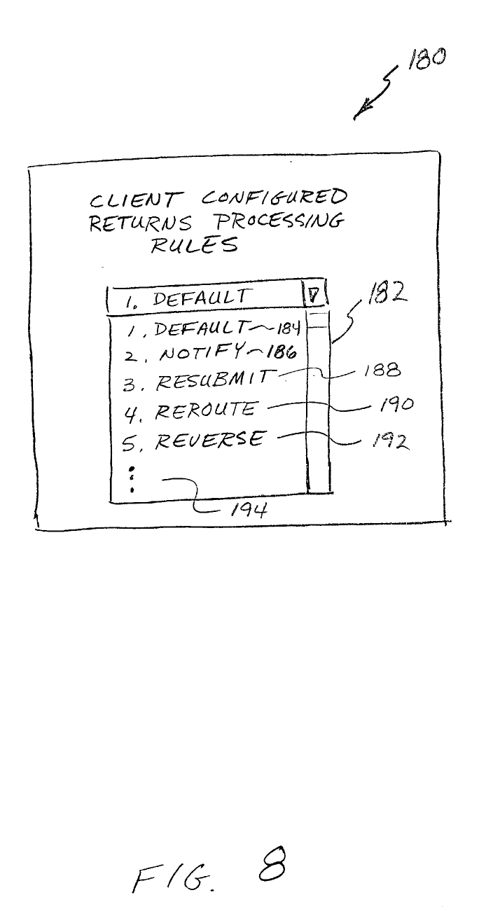

FIG. 8 is a partial screen view of a display screen, generally indicated by reference numeral 180, for enabling selection of a custom configured dishonored items processing rule according to one embodiment. For example, a system administrator for a client may select a custom configured dishonored items processing rule for use with dishonored items during an initial configuration of the system for client customer usage. That is, the system administrator may select the rule from a drop-down list of rules 182. The rules may include, for example, a default rule 184, a notify rule 186, a resubmit rule 188, a reroute rule 190, a reverse rule 192, as well as other rules 194 adapted for use in a given implementation. During dishonored items processing, the system utilizes the corresponding custom configured returns processing rule.

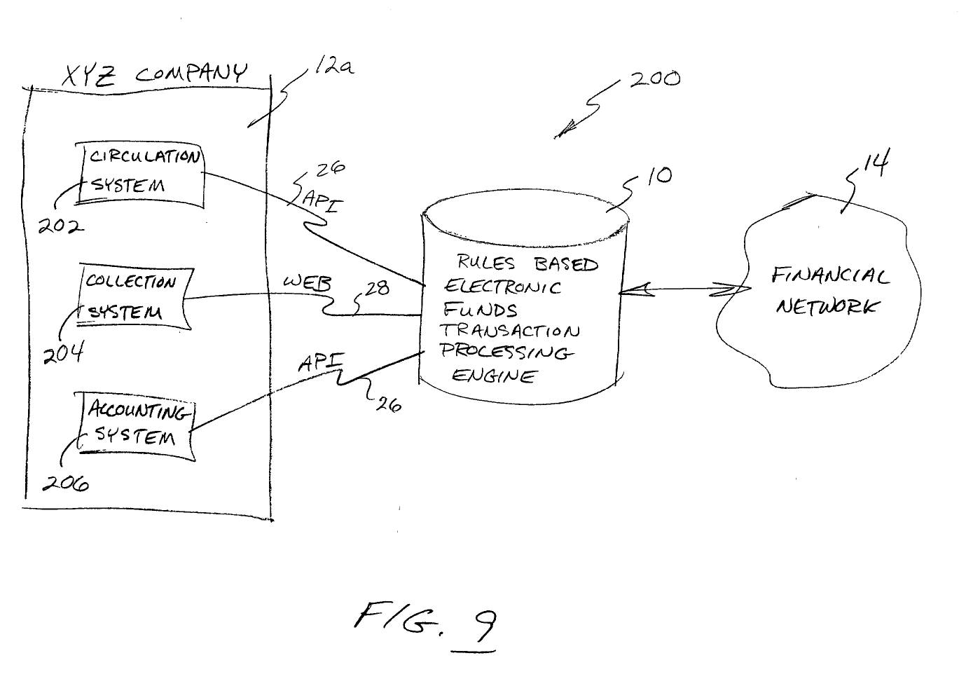

FIG. 9 shows a block diagram view, generally indicated by reference numeral 200, of an integrated rules based electronic funds transaction processing system according to one embodiment. In this embodiment, the XYZ company system 12a is integrated with the rules based electronic funds transaction processing engine 10 via one or more interfaces (26, 28), for performing electronic funds transaction processing on the financial network 14, the engine including at least one rule configured for to process electronic funds clearinghouse dishonored items. For example, a circulation system 202 of the XYZ company system interfaces with the engine 10 via an API 26. A collection system 204 interfaces with the engine via a web interface 28. An accounting system 206 interfaces with the engine 10 via another API 26. Accordingly, the rules based electronic funds transaction processing of the present disclosure can be integrated to one or more portions of a company system as deemed appropriate for the particular requirements of the company.

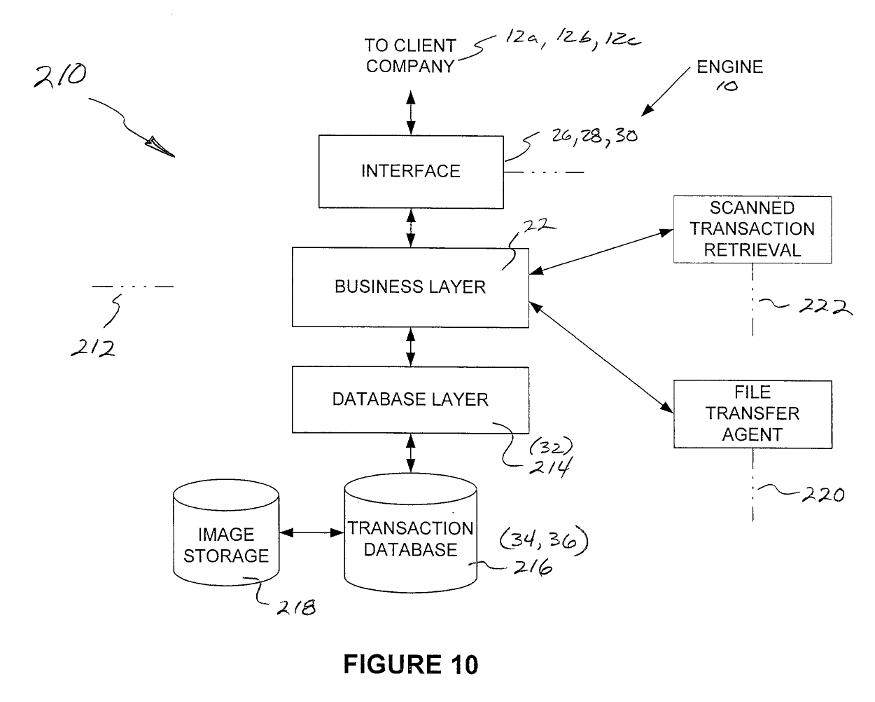

FIG. 10 is a block diagram view, generally indicated by reference numeral 210, of a system for rules based electronic funds transaction processing according to another embodiment. As shown in FIG. 10, the system can be configured as a plurality of engines 212 making use of a common database layer 214, transaction database 216, and image storage 218. Accordingly, the system can be configured, via a number of file transfer agents 220, for operating with more than one originating financial depository institution (ODFI), agent of an ODFI, and electronic funds financial clearinghouse network. The system may further be configured for receiving data from one or more scanned transaction retrieval module 222. The system may still further be configured as a stand alone system for use with a single client or source entity (12a), or used in a hosting system manner, for hosting the electronic funds financial transaction processing for a number of different client companies (12a, 12b, 12c) for a number of different ODFIs, agents of ODFIs, and electronic funds financial transaction networks.

In another embodiment, the system further includes a scanned transaction retrieval module 222. The scanned transaction retrieval module 222 scans images of paper financial transaction payment instruments, for example, personal checks or bank drafts. The scanned transaction retrieval module is configured to separate Magnetic Ink Character Recognition (MICR) and transaction data detail from the image detail of the scanned image of the paper financial transaction payment instrument. The scanned transaction retrieval (STR) module 222 operatively connects to the business layer 22 for transferring at least one of MICR data and transaction data to the business layer, the business layer further for processing corresponding electronic funds transaction data according to at least one of the multiple independent rules based processing rules. In another embodiment, transmission of the image may also occur outside of the STR module via the utilization of an Application Programming Interface (API). In the latter instance, the image is temporarily stored on a local machine connected to scanning equipment via suitable hardwire/wireless connection, and the image is then transferred via web posting technology to the business layer 22.

With respect to the scanned transaction retrieval module, the at least one of multiple independent rules based processing rules of the system includes a rule configured to determine a clearinghouse eligibility of the transaction items. Determination of the clearinghouse eligibility can be based upon the MICR data and/or transaction data of the respective transaction item. In one embodiment, determining clearinghouse eligibility includes comparing a transaction amount of the transaction data with a character or image recognition component of the transaction amount obtained from the image detail of the transaction item.

In another embodiment, the system further comprises an image storage 218. The image storage 218 operatively connects to the database storage and the business layer. In this embodiment, the scanned transaction retrieval (STR) module is further configured to transfer the scanned image to the business layer 22. Responsive to a storage request from the business layer 22, the image storage 218 stores the scanned image of the paper financial transaction payment instrument. The database storage 36 is further configured to store the corresponding MICR data and transaction data of the scanned image.

In a yet another embodiment, the business layer 22 assigns a transaction number to the scanned image of the paper financial transaction payment instrument, the transaction number relating to a transaction trace number of the corresponding transaction item. The business layer 22 assigns the transaction number in a manner for relating it to a transaction trace number of the corresponding transaction item. As indicated herein, the transaction trace number includes at least one of the following selected from the group consisting of a number based upon an algorithm, a sequence number based upon prior transaction processing, and a concatenation of a financial institution identification number with a current trace number, the current trace number representing a number in a sequence of transaction items.

Further in connection with the embodiments discussed above, the scanned transaction retrieval module 222 separates MICR and transaction data detail from image detail of a scanned image of a paper financial transaction payment instrument. The scanned transaction retrieval module operatively connects to the business layer 22 for transferring either one or both of the MICR data and transaction data to the business layer for processing the corresponding electronic funds transaction data according to at least one of multiple independent rules based processing rules. In one embodiment, the rules based processing rule determines a clearinghouse eligibility of the transaction item based upon at least one of the MICR data and transaction data of the transaction item.

Responsive to a determination of eligibility, the business layer further operatively connects to the file transfer agent and enables the file transfer agent to build the data file with eligible electronic funds transaction data. In response to building the data file, the file transfer agent routes the data file to at least one of the financial institution, the agent of a financial institution, and the electronic funds transaction clearinghouse network, for placement of the data file on the electronic funds transaction clearinghouse network.

Responsive to a determination of ineligibility, the business layer processes the ineligible electronic funds transaction data according to at least one rule configured to process ineligible electronic funds transaction data. The business layer furthermore operatively connects to the file transfer agent and enables the file transfer agent to build a second data file with ineligible electronic funds transaction data. For example, at least one rule configured to process ineligible electronic funds transaction data includes a rule for routing image detail of the ineligible electronic funds transaction data items to a second clearinghouse network for processing the ineligible electronic funds transaction data items as image items.

Further in accordance with at least one of an eligibility and an ineligibility for electronic funds transaction clearinghouse network processing of a corresponding electronic funds transaction item, the database layer stores at least one of (a) the corresponding MICR and transaction data detail of the scanned image of eligible electronic funds transaction items in the database storage and (b) the corresponding scanned image of the paper financial transaction payment instrument of ineligible electronic funds transaction items in the image storage.

In connection with the previous discussion and FIG. 8, the custom configured business rule for dishonored item processing may include one or more rules to (a) provide notice of the dishonored item (186), (b) resubmit the dishonored item (188), (c) reroute the dishonored item (190), and (d) initiate, according to the transaction data of the dishonored item, at least one of the group consisting of reversing a recorded transaction, causing a reversal, and causing a reverse posting to at least one of an external system and an accounting database (192). For example, providing notice of the dishonored item may include providing a client with a custom configured notice of the dishonored item.

Resubmitting the dishonored item may include rendering a representment of the dishonored transaction data to the electronic funds transaction clearinghouse network as a new transaction item. In such an instance, the business layer determines an eligibility of the dishonored transaction data for representment. In response to a determination of eligibility, the business layer enables the file transfer agent to modify the dishonored transaction data by replacing the transaction trace number of the dishonored transaction data with a second transaction trace number. The business layer further provides suitable means for storing the transaction trace number and the second transaction trace number in a dishonored trace audit table for tracking dishonored transaction items.

Further in connection with resubmitting the dishonored item, the file transfer agent proceeds with building the data file with at least one of the processed electronic funds transaction data and the modified dishonored transaction data. In response to building the data file, the file transfer agent transfers the data file to at least one of the financial institution, an agent of a financial institution, and an electronic funds transaction clearinghouse network for placement of the data file on the electronic funds transaction clearinghouse network.

Rerouting the dishonored item may include routing the dishonored transaction data according to a custom configured rerouting rule. Initiating a reversal of the recorded transaction according to the transaction data of the dishonored item may includes initiating a reversal of a corresponding transaction entry in at least one of a client general ledger and a client external system.

In one embodiment, the business layer 22 operatively connects to a WEB interface 28 for receiving electronic funds transaction data. The WEB interface can be configured for accepting electronic funds transaction originations. Such originations may include at least one origination selected from the group consisting of Magnetic Ink Character Recognition (MICR) check scan, Point-of-Purchase, Mail order, Telephone order, Lockbox, and Accounts Receivable. In addition, the interface is further configured to support thick clients and/or thin clients.

In another embodiment, the system includes an interface configured to operatively couple and integrate the system for rules based electronic funds transaction processing with a client system. In this embodiment, the client system can be configured for accepting electronic funds transaction originations from one or more originations of Magnetic Ink Character Recognition (MICR) check scan, Point-of-Purchase, Mail order, Telephone order, Lockbox, and Accounts Receivable. The client system may further include an external database, a point of sale database, a remittance processing database, and/or a remittance processing application.

The interface may still further include a modular design configurable to the particular requirements of the client system. For example, referring once again to FIG. 1, the particular requirements of the client system 12b may include requirements relating to at least one selected from the group consisting of MICR check scan 230, Point-of-Purchase 232, Mail order 234, Telephone order 236, Lockbox 238, Accounts Receivable 240, Internet commerce 242, and wireless device 244. The interface may still further be configured to support thick and/or thin clients.

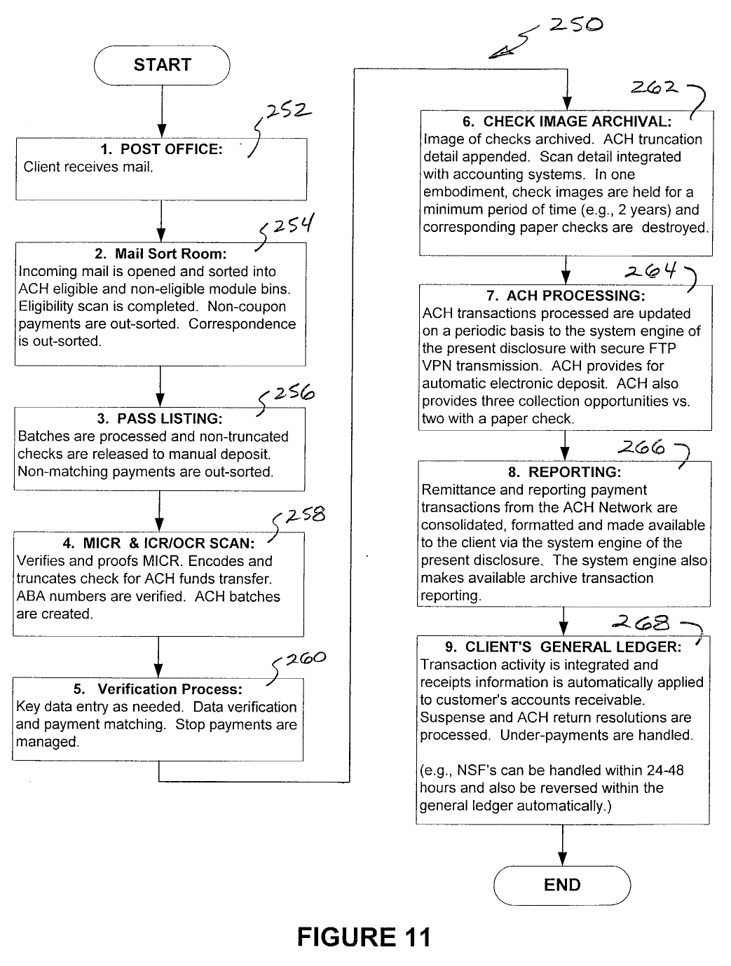

Turning now to FIG. 11, a flow diagram view of an accounts receivable conversion work flow, generally indicated by reference numeral 250, according to one embodiment of the present disclosure shall now be discussed. In a first step (252), a client picks up mail at the post office or other delivery location. In a next step (254), incoming mail is opened and sorted into financial network eligible and non eligible module bins. Upon a completion of eligibility scan, non-coupon payments are out sorted, as well as correspondence. In a next step (256), batches are processed and non-truncated checks are released to manual deposit. In addition, non-matching payments are out-sorted. In a next step (258), MICR and OCR scan take place. This step verifies and proofs MICR data, encodes and truncates check for financial network funds transfer. ABA numbers are verified. Network ready data files are created.

The next step (260) included a verification process. Verification includes keying data entry as needed, data verification and payment matching, and managing of stop payments. In a next step (262), images of checks are archived. Financial network truncation detail appended. Scan detail integrated with accounting systems. In one embodiment, check images are held for a predetermined period, for example, 2 years. In addition, upon a completion of the check image archival, paper checks destroyed. During the next step (264), the transactions are processed on a periodic basis, and updated to the system engine with secure file transfer protocol virtual private network (FTP VPN) transmission. Using the system engine, the financial network provides an automatic electronic deposit. In addition, the system engine provides an ability for three collection opportunities versus two with the traditional paper check route. In a next step (266), the system engine provides for remittance and reporting payment transactions from the financial network to be consolidated, formatted and made available to the client. The system engine can further be configured to provide archived transaction reporting. In a final step (268), transaction activity is integrated and receipts information is automatically applied to a customer's accounts receivable. Suspense and financial network return resolutions are processed. Under-payments are handled. For example, NSF's are handled within a time period of approximately 24-48 hours and can be reversed within a respective general ledger automatically via the system engine.

According to another embodiment of the present disclosure, a method for rules based electronic funds transaction processing includes processing electronic funds transaction data received from a source according to at least one of multiple independent rules based processing rules. The rules based processing rules include at least one rule configured to process electronic funds clearinghouse network dishonored items. For example, at least one rule processes network dishonored items on a case by case basis.

Subsequent to processing the electronic funds transaction data, the method initiates a request to build a data file from the processed electronic funds transaction data. In response to building the data file, the method transfers the data file to at least one of a financial institution, an agent of a financial institution, and an electronic funds transaction clearinghouse network for placement of the data file on an electronic funds transaction clearinghouse network. The data file includes a network ready data file having a format at least in accordance with requirements of the electronic funds transaction clearinghouse network. In one embodiment, the data file includes an ACH-Ready file and the electronic funds transaction clearinghouse network includes the ACH Network.

In one embodiment, the step of processing of the electronic funds transaction data utilizes a business layer of a system configured to implement rules based electronic funds transaction processing. The step of initiating the request to build a data file from the processed electronic funds transaction data utilizes a file transfer agent of the system.

According to another embodiment, the system 10 includes a computer system programmed for performing functions as described herein, using programming techniques known in the art. The computer program includes instructions processable by the computer system for carrying out rules based electronic funds transaction processing as discussed herein. For example, the program includes instructions for receiving electronic funds transaction data from a source and processing the electronic funds transaction data according to at least one of multiple independent rules based processing rules. The rules based processing rules include at least one rule configured to process electronic funds clearinghouse network dishonored items. In addition, at least one rule is configured to process network dishonored items on a case by case basis.

The computer program further includes instructions for initiating a request to build a data file from the processed electronic funds transaction data. In response to building the data file, the instructions include transferring the data file to at least one of a financial institution, an agent of a financial institution, and an electronic funds transaction clearinghouse network for placement of the data file on an electronic funds transaction clearinghouse network. In one embodiment, the data file includes a network ready data file having a format at least in accordance with requirements of the electronic funds transaction clearinghouse network. In one embodiment, the data file includes an ACH-Ready file and the electronic funds transaction clearinghouse network includes the ACH Network.

In another embodiment, the computer program further comprises instructions for importing the electronic funds transaction data from the source via an interface. In addition, processing the electronic funds transaction data according to at least one of multiple independent rules based processing rules includes preventing a processing of the received electronic funds transaction data if at least one of source credentials of the source and interface credentials of the interface is invalid. The computer program still further comprises instructions for processing a request received from the source in connection with the electronic funds transaction data and for providing a response to the source via the interface.

In yet another embodiment, the computer program further comprises instructions for performing an action in response to (a) a client source configured query and/or (b) a client source configured request. For example, the client source configured query may include a transaction history query. The client source configured request may include a transaction creation request and/or a recurring transaction modification request.

In yet another embodiment, the computer program further comprises instructions for performing an action in response to a hosting system query. For example, in connection with a hosting system query, the instructions may include accessing a Positive/Negative database and processing the electronic funds transaction data as a function of Positive/Negative data in the Positive/Negative database.

The computer program further includes instructions for retrieving dishonored item data from at least one of the financial institution, the agent of the financial institution, and the electronic funds transactions clearinghouse network. In addition, the computer program includes instructions for processing the dishonored item data according to (a) a rules based processing rule and/or (b) an electronic funds financial transaction clearinghouse network rule.

The computer program still further includes instructions for assigning a transaction trace number to each transaction item of the processed electronic funds transaction data, prior to a transferring of the network ready data file to at least one of the financial institution, the agent of the financial institution, and the electronic funds transaction clearinghouse network. The transaction trace number enables tracking of a corresponding transaction item during dishonored items processing of a dishonored items data file retrieved from at least one of the financial institution, the agent of the financial institution, and the electronic funds transaction clearinghouse network. The computer program further includes instructions for processing the dishonored items according to at least one of a custom configured business rule and an electronic funds transactions clearinghouse network dishonored items rule.

In one embodiment, the transaction trace number includes a number based upon an algorithm, a sequence number based upon prior transaction processing, and/or a concatenation of a financial institution identification number with a current trace number. In the later instance, the current trace number represents a number for use with a next transaction item in a series of transaction items.

According to a further embodiment, the computer program includes instructions for storing the assigned transaction trace numbers with the corresponding transaction data of the processed electronic funds transaction data. The computer program further includes instructions for performing data manipulation of the processed electronic funds transaction data according to (a) dishonored items processing rules and (b) a tracking of dishonored transaction items via respective transaction trace numbers. The computer program still further includes instructions for storing information for tracking dishonored transaction items.

In the immediately preceding paragraph, the information for tracking dishonored transaction items includes initial transaction trace numbers corresponding to trace numbers of transaction items prior to respective ones of the transaction items becoming dishonored transaction items. Subsequent transaction trace numbers correspond to trace numbers of dishonored transaction items prior to respective ones of the dishonored transaction items becoming subsequent dishonored transaction items.

In another embodiment, the computer program still further includes instructions for separating (a) Magnetic Ink Character Recognition (MICR) and transaction data detail from (b) image detail of a scanned image of a paper financial transaction payment instrument. The MICR and transaction data detail provide the electronic funds transaction data for processing according to at least one of multiple independent rules based processing rules. The multiple independent rules based processing rules includes a rule configured to determine a clearinghouse eligibility of a transaction item based upon the MICR data and/or transaction data of the MICR and transaction data detail of the transaction item. In one embodiment, determining the clearinghouse eligibility includes comparing a transaction amount of the transaction data with a character recognition component of the transaction amount obtained from the image detail of the transaction item. In addition, the computer program still further includes instructions for storing the scanned image of the paper financial transaction payment instrument, and storing the corresponding MICR and transaction data detail of the scanned image.

Additional embodiments of the computer program include instructions for carrying out other functionalities as discussed herein with respect to the system and method of rules based electronic funds transaction processing.

Accordingly, the embodiments of the present disclosures facilitate an efficient, reliable, secure shift from paper based check payment and manual accounts receivable processing systems. The present embodiments further provide an electronic funds network clearinghouse transaction integration technology. According to one embodiment, the method and system utilize the ACH network as a backbone, as well as the efficiency of the Internet, to implement and integrate customers' electronic payment management systems.

The method and apparatus of the present disclosures also focus on reducing internal expenses and improving cash flow by integrating back-end accounting and customer service systems in a low cost manner with the ACH Network. For example, integrating back-end accounting and customer service systems with the ACH network can be carried out for commercial entities, their suppliers, and their customers. The embodiments further facilitate and provide a method and system of high security, quality, integrity, and value.

The method and system of the present disclosures can advantageously assist with the high volume secure electronic payment transaction processing needs of various organizations, including for example, mortgage, insurance, and public works utilities. For example, in electronic commerce that utilizes recurring ACH transactions, the method and system of the present disclosures enables providing of very efficient ACH electronic payment processing services. In a further example, a utility company may receive 40 million paper check payments for a given service period. If the utility company were required to manually process failed transactions of the 40 million transactions, the task would be highly labor intensive and subject to errors, as well as subject to other difficulties and disadvantages. However, the present disclosure describes an improved method and system for handling automated correction of such high volume electronic payment transaction processing, especially that of failed transaction items.

The embodiments of the present disclosure can also be configured as integrated ACH transaction outsourcing solutions, including payment service systems and processing integration, thereby allowing clients to accept virtually any type of ACH payment, including Internet (Web-to-Cash(™)), telephone, wireless or lockbox (PayVault(™)) transfer of funds .The embodiments are adaptable to emerging ACH payment trends. For example, the engine (ACH Anywhere (™)) follows published NACHA rule sets and allows payment authorization, risk management services, and seamless updates to accounting ledgers across a broad platform of systems.

ACH Check Truncation

In addition, the system engine can be configured to handle ACH check truncation. Check truncation is a process of converting a paper check to an electronic item that can be presented and returned through the Automated Clearing House (ACH) system. Check truncation allows remittance processing system (RPS) originators to convert checks that the originators received through the U.S. Mail system, at the merchant point of sale, on the Web, wireless, or over the telephone. Each transaction type is governed by its own rule set from NACHA.

ACH check truncation with the use of system and method of the present disclosures provides a number of benefits. The benefits can include one or more of the following: an improved NSF discovery period, with no NSF charges; lower processing costs; time and money savings; lower bank fees; decrease in float time enabling quicker collection; improved cash flow; increased collection rate on dishonored items; reduced risk from returns processing, as well as, quicker returns processing; enabling execution of electronic check payments at the lockbox, by phone, the web, or via wireless; online real-time reporting of electronic payment transactions; reduced fraud, as well as, enhanced fraud detection effectiveness; enabling a three time “opportunity” to collect, virtually eliminating most NSF bank fees; banking relationship consolidation for a client with capability for conversion of funds at each location of the client; electronically depositing of checks, eliminating lost or stolen checks before deposit; information, reporting, database records management; integration with accounting general ledger systems of clients; and other benefits.

In one embodiment, the engine 10 integrates with a client's website to enable the client's customers to pay for purchases on-line with a check. Accordingly, integration of the engine with the website makes accepting checks over the Internet as easy as accepting a credit card payment. The same can apply with respect to phone or fax authorized payments.

The engine and method 10 of the present disclosures improve cash flow, collection time and processing time by allowing a client to transform up to 100% of the client's non-cash payments into electronic format. The engine and method 10 increase efficiencies and reduce errors associated with re-keying data, for example, by integrating with a client's existing software and being configured to automatically post transactions to the client's accounting system.

According to another embodiment, the engine and method 10 are configured to integrate with third party services that provide access to fraud screening and risk assessment databases. The engine and method are also configured to integrate with hardware scanners that convert paper checks to electronic items and to capture entire images of the checks being processed. As a consequence, the engine and method reduce transaction processing costs, compared to standard paper check processing costs and wire transfer costs. In addition, in one embodiment, since the ACH payments are electronic and batched, reconciliation is more automated than manual paper systems.

According to another embodiment, the system engine of the present disclosures enables a client to bank anywhere. The system engine provides flexibility, for example, a client may originate transactions with pre-established financial institutions associated with the engine, or the client may choose to maintain their existing banking relationships and use their own financial institution for origination. In either case, upon completion of electronic payment transaction processing, funds are deposited directly into the client's bank account.

The engine 10 is configurable to allow for custom alerts and automated return item processing. That is, the custom alerts and automated return item processing can be configured to meet the client's distinct rules and needs.

In one embodiment, the engine connects to any financial institution capable of accepting the secure transmission of a “Fed-Ready” ACH file. The engine can also connect a client's accounting system to the ACH Network environment. The engine interfaces between a client's accounting system and the ACH Network according to the functionalities as described herein, with the use of interfacing and programming techniques as known in the art. For instance, the types of programming technologies to be used may include: HTTP posting, SOAP, or any other suitable programming technology.

As discussed herein, the engine is driven by a multi-layered, software-based process that sends and receives ACH requests, stores transaction detail, processes alerts, and performs archiving functions.

Web-to-Cash(™)

In one embodiment, the system is configured as a browser-based application that allows a user to enter and track ACH transactions via the Internet (the Web-to-Cash(™) browser-based application). Accordingly, a client can initiate an ACH transaction utilizing an Internet-based environment, with improved collection time and cash flow. The Web-to-Cash(™) browser based application allows clients the opportunity to access the ACH Network and convert payments into an electronic format. The Web-to-Cash(™) browser-based application integrates with a client's existing website to allow the client's customers to pay with checks online.

The Web-to-Cash(™) browser-based application allows for push and pull of funds, i.e., enabling a client to collect from the client's customers or to send money to the client's suppliers. The Web-to-Cash(™) browser-based application provides ease of handling recurring payments. For example, a transaction can be entered one time to pull $100.00 from a customer's account for five consecutive months for a total of $500.00. The Web-to-Cash(™) browser-based application is capable of sending funds to any financial institution capable of accepting ACH transactions, allowing clients to maintain their existing bank relationships.

In addition, the browser-based application includes a capability of sending funds to any financial institution capable of accepting ACH transactions, allowing clients to maintain their existing banking relationships. The browser-based application couples with the engine for combining the power of the Internet with the security and reliability of the NACHA-regulated ACH Network. Utilizing this power, businesses and organizations can increase their cash flow and reduce costs, making their respective businesses more profitable and cost effective.

In the specific area of providing lockbox accounts receivable check truncation services, the engine 10 includes hardware, software and archive imaging and transport solutions. The hardware, software and archive imaging and transport solutions may include, for example, mail handling equipment, transport check MICR and OCR encoders, image scanners and image archival systems.

In yet another embodiment, the system is configured as an e-check application to convert paper checks into electronic ACH debits at remittance and lockbox locations, referred to herein as the PayVault(™) application. Under new rules, a paper check that a customer mails to a biller's remittance or lockbox location may be converted into an ACH debit. At the remittance location, the biller can electronically capture payment information, including the bank's routing number and customer's account number.

Using the system of the present disclosures configured as the PayVault(™) application, the payment information is then used to create an ACH debit to the consumer's account. ACH debits are covered by the Federal Reserve's Regulation E, which defines specific consumer protections from error and fraud. There are no similar protections for paper check payments. And, unlike a paper check transaction, the name of the payee will appear on the consumer's monthly statement when an e-check is used.

The system and method of the present disclosures, configured as the Vencheck(™) application, can potentially save approximately 40-80% per transaction compared to credit card fees. The system and method can further reduce overhead and eliminate significant costs of paper processing. Still further, the system and method can be configured to be fully compliant with all NACHA requirements regarding Internet check transactions.

ACH transaction and integration can provide significant cost savings and enhance cash flow for a client. A client may include one or more clients from the following business segments, for example, 1) public works, including electricity, water, and gas utilities; 2) insurance; and 3) mortgage service industries. A client may also include one selected from catalog companies and online retailers, newspaper publishing companies, bill and statement printing providers, telecommunication providers, property management companies, credit card processors, consumer finance companies, leasing companies, collection services companies, hospitals and medical providers, interactive voice response (IVR) for telemarketing call centers, government entities, non-profits, charities, accounting software companies, and any other similar client.

The engine 10 enhances a company or organization's cash management techniques by coupling with related technologies to accelerate cash flows, manage and seamlessly integrate accounts receivable and inventory systems, precisely control cash disbursements, reduce borrowing needs, reduce NSF costs, reduce operations cost and improve earnings and maximize use of operating capital. Using the ACH Network, the engine 10 allows companies with geographically dispersed offices to move money quickly and draw funds into centralized accounts from widely scattered financial institutions or disburse funds as needed. For businesses and organizations that need to move or receive money, the engine 10 provides a gateway connection to the ACH Network. The engine 10 further provides a comprehensive processing to settlement and reporting module to put a bank's retail, commercial and organizational clients in the business of paperless check payments, in-store or online.

The present embodiments can be configured to enable integration of off-line and online technologies. In one embodiment, the engine 10 provides connectivity as well as reliability of the funds transfer capabilities of the ACH Network. The engine 10 provides tools configurable to fit within a company's present order processing infrastructure, for example, including check verification, accounting, and inventory control systems. The engine is furthermore adaptable for future automation change.

According to one embodiment, the processing engine 10 uses a web to cash front-end for client access to the financial network electronic transaction processing. The transaction processing engine 10 also integrates with back-end system and is configured to automatically send the client and/or the client's accounting department an ACH transaction confirmation.

The embodiments of the present disclosure facilitate software customization at the database level and can also extend a client's custom service(s) for customized transaction processing, collections, accounting, sales order processing, CRM, and inventory control integration.

The embodiments of the present disclosure can be configured to provide ACH payment processing services (financial network electronic transaction services) on a direct basis to technology providers and companies serving as independent sales organizations, which in turn sell those services to one or more target markets, for example, public works, insurance, mortgage service industry, and others.

The method of financial network electronic transaction payment processing according to the embodiments of the present disclosure enables for an efficient providing of ACH electronic payment processing services by providing a capability for downward management of per transaction operating costs. The method also provides a vertical integration model for a payment services business, capable of being configured as necessary for addressing emerging ACH payment trends. According to one embodiment, the engine 10 is configured to follow published NACHA Rule sets and allow for payment authorization, risk management services, and seamless updates to accounting ledgers across a broad platform of systems.

According to one embodiment, the engine of the present disclosure can be configured to integrate transaction reconciliation reporting with any number of client accounting systems. Responsive to receipt of a transaction file containing transaction data from a client, wherein the data is arranged in a client custom configured format, the engine 10 assigns a unique identifier to each transaction of the transaction file. More particularly, the engine 10 creates a unique trace number (tracenum) for each transaction and stores the unique trace number and the transaction data in a modified transaction file. The engine saves the modified transaction file, for example, to use the modified transaction file subsequent to batch processing by the financial electronic transaction network.

With rules based processing, the business layer of the engine 10 adds value to each transaction, prior to the transactions being processed via batch processing in the ACH Network or other financial electronic funds transaction processing network. Rules based processing of the transaction file may include one or more of the following set of rules:

1) compare select components of a transaction against a 3^{rd} party database (e.g., POS/NEG, Scan, OLFAC, NDS list);

2) compare select components of a transaction against custom client configured and/or specified rules (e.g., mortgage industry client rule to not accept any payment that is less than full payment of a monthly mortgage payment due amount.);

3) compare select components of a transaction as against legal rules and requirements (i.e., PATRIOTS ACT);

4) perform custom transaction routing based on transaction detail; and

5) assign a unique identification to each transaction, for example, using trace numbers;

In one example, a mortgage company client may desire for any remittance transaction of a transaction file that fails to include a sufficient mortgage payment not be accepted. That is, for a given remittance transaction, the monetary amount to be paid is insufficient if the amount fails to cover the required mortgage payment amount. Accordingly, the business rule executed by the engine 10 for the mortgage company client can include creating a stop file for insufficient remittance transactions. Upon completing the processing of the mortgage company client's transaction file, the engine 10 may provide suitable notification of the insufficient remittance transactions to the mortgage company client, or carry out further processing according to client directives. Transactions which were successfully processed by the engine into the modified transaction file are then forwarded to the appropriate ODFI for processing via the ACH Network.

Accordingly, the rules applied by the business layer of the engine 10 can be specified by a client for applying to each transaction of a client transaction file. The rule may include comparing select content of each transaction data with content from a given database, such as a third party database or other database. Upon satisfaction of the rule, the engine 10 creates a stop file containing corresponding transaction data, preventing the affected transaction data from being forwarded to the financial electronic funds transaction processing network.

The database layer of the engine 10 uses database layer processing of the modified transaction file created by the business layer to write modified transactions to a transaction database. That is, each transaction of the client provided transaction file is written to a modified transaction file and assigned a status of the modified transaction. For example, the status may include: pending, failed, submitted, and cleared. In one embodiment, pending may represent that the modified transaction data has been accepted into the transaction database, but not yet sent to the ODFI, and thus not in the ACH Network. Failed may represent that the modified transaction has failed for a particular reason. Submitted may represent that the modified transaction has been sent to the ODFI and submitted to the ACH Network for payment processing. Lastly, cleared may represent that payment processing by the ACH Network has been completed and the funded according to the given transaction.

The file transfer agent (FTA) includes a separate process or module of the engine 10. The FTA responds at an engine specified time for calling the business layer and further processing the modified transaction file according to custom rule set processing (i.e., an ODFI processing rule set). For example, the FTA may call the business layer, using rules defined for construction of a file to be transmitted to the ODFI. For the ACH Network, the file may include a Fedready file.

The FTA builds a Fedready file by assigning FED Trace Numbers, recognizable by the ACH Network, to each transaction of the modified transaction file. The FTA creates the Fedready file according to the requirements of a financial clearing house network batch file. Subsequent to creation of the Fedready file, the FTA transmits the Fedready file to the financial clearing house, via an ODFI. In one embodiment, an FTA is configured to deal with one ODFI. The FTA may include a custom FTA for meeting requirements of a particular ODFI. Along with transmission of the Fedready file to the ODFI, the FTA queries the ODFI for any returns that the FTA is to retrieve. In other words, the FTA queries the ODFI for exception items generated by the ACH Network with respect to previously transmitted transactions.

In response to the query, the FTA obtains a returns file of exception items from the ODFI. The FTA takes the return file from the ODFI and calls the Business Layer to find out what Engine return rules to apply, and based upon the Engine rules, processing the returned transactions to uncover the originating transaction date via the modified transaction file.

With the ACH Network, it may take a minimum of two business days for the return file to indicate that a transaction has failed. The engine matches the failed transactions to the originating transactions in the transaction database.

The FTA processes each of the transactions in the return file to determine if the FTA recognizes each of the transactions. In one embodiment, the FTA processes each transaction of the return file to determine a match with a pre-stored transaction origination. If no match is found, then the failed transaction is unaccepted and the FTA sends the failed transaction data back to the ODFI and ACH Network as unrecognized.

For recognized failed transactions, the FTA passes accepted failed transactions to the database layer for DB Layer processing. Database Layer processing includes updating a respective transaction data in the transaction database with information (i.e., reason code, Fed Trace Number, etc.). Database Layer processing further includes toggling the status field of respective modified transactions. That is, the database layer toggles the status field from “submitted” to “failed”, as well as associating a reason code with the failure, as supplied by the return file.

At an engine specified time, the business layer 22 processes failed transactions stored in the transaction database against or according to a client specified rule set. For example, the client specified rule set may contain a directive for one or more of the following: a) provide an electronic notification to the client that a certain transaction or transactions have been returned unpaid, b) automated resubmission of the transaction, the automated resubmission being a function of the return code, c) sending output data to one or more remote client controlled applications, customer relationship management (CRM), A/R, and general ledger applications.

The engine includes computer program software for executing the functions as described herein. Programming of the software to carry out the functions as described herein can be accomplished using programming techniques known in the art.

In one embodiment, returns management of the method and system of the present embodiments includes suitable program code configured to cause the engine 10 to match failed transactions with originating transactions via each transaction's unique trace number, transaction Id, and/or federal trace number. The returns management also keeps track of the failed transactions that are subsequently resubmitted to the ODFI in a subsequent Fedready file, and the number of times that the same transaction is returned as failed from the ODFI and ACH Network. Because of the batch processing nature of the ACH Network, each submission of a transaction in a Fedready file is viewed by the ACH Network as a new transaction. Accordingly, the returns management of the engine provides a method for tracking of the failed transactions, and the number of times a given transaction has been returned from the ACH network as “failed.” In addition, the returns management of the engine 10 enables an assurance that a maximum number of resubmissions is not exceeded. In other words, the engine 10 returns management function is configured to monitor the number of times that a given transaction has been submitted to the ACH Network and returned as a failed transaction, such that, the NACHA rules are respected (i.e., no more than 3 submissions per transaction).

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A system for rules based electronic funds transaction processing comprising:
a business layer configured to receive electronic funds transaction data from a source and to process the electronic funds transaction data according to at least one of multiple independent rules based processing rules including at least one rule configured to process electronic funds clearinghouse network dishonored items; and
a file transfer agent operatively connected to said business layer for initiating a request to build a data file from processed electronic funds transaction data, and in response to building the data file, transfer the data file to at least one selected from the group consisting of a financial institution, an agent of a financial institution, and an electronic funds transaction clearinghouse network for placement of the data file on the electronic funds transaction clearinghouse network, the data file including a network ready data file having a format at least in accordance with requirements of the electronic funds transaction clearinghouse network.

2. The system of claim 1, wherein at least one rule is configured to process electronic funds clearing house network dishonored items on a case by case basis.

3. The system of claim 1, wherein at least one of multiple independent rules based processing rules includes at least one selected from the group consisting of a custom configured business rule and a hosting system business rule.

4. The system of claim 3, wherein the source includes a biller and wherein the custom configured business rule prevents submission of a transaction item of the electronic funds transaction data to the electronic funds transaction clearinghouse network if the transaction item contains a transaction amount for less than a transaction amount owed.

5. The system of claim 1, wherein the data file includes an ACH-Ready file and the electronic funds transaction clearinghouse network includes the ACH Network.

6. The system of claim 1, further comprising:
an interface configured to import the electronic funds transaction data from the source to said business layer.

7. The system of claim 6, wherein source credentials identify the source, interface credentials identify the interface, and at least one of multiple independent rules based processing rules includes a verification rule configured to prevent processing of the received electronic funds transaction data if at least one of source credentials and interface credentials is invalid.

8. The system of claim 6, further wherein said interface is configured to receive a request from the source in connection with electronic funds transaction data, and said business layer is further configured to process the request and provide a response to the source via said interface.

9. The system of claim 1, further comprising:
a database layer operatively connected to said business layer, wherein said business layer and said database layer are configured to perform an action in response to at least one selected from the group consisting of (a) a client source configured query, (b) a client source configured request, and (c) a hosting system query.

10. The system of claim 9, wherein said business layer is further configured to receive the client source configured query and the client source configured request via an interface, the client source configured query including a transaction history query and the client source configured request including at least one of a transaction creation request and a recurring transaction modification request.

11. The system of claim 1, wherein said business layer is further operatively connected to a Positive/Negative database and configured to process the electronic funds transaction data as a function of Positive/Negative data in the Positive/Negative database.

12. The system of claim 1, wherein said file transfer agent is further configured to retrieve dishonored item data from at least one of the financial institution, the agent of the financial institution, and the electronic funds transactions clearinghouse network, wherein said business layer is further configured to process the dishonored item data according to at least one of the group consisting of (a) a rules based processing rule and (b) an electronic funds transaction clearinghouse network rule.

13. The system of claim 1, further wherein, prior to a transferring of the network ready data file to at least one of the financial institution, the agent of the financial institution, and the electronic funds transaction clearinghouse network, said business layer is configured to assign a transaction trace number to each transaction item of the processed electronic funds transaction data, wherein the transaction trace number is configured to enable tracking of a corresponding transaction item during dishonored items processing of a dishonored items data file retrieved from at least one of the financial institution, the agent of the financial institution, and the electronic funds transaction clearinghouse network, and further wherein said business layer is configured to process the dishonored items according to at least one of a custom configured business rule and an electronic funds transaction clearinghouse network dishonored items rule.

14. The system of claim 13, wherein the transaction trace number includes at least one selected from the group consisting of a number based upon an algorithm, a sequence number based upon prior transaction processing, and a concatenation of a financial institution identification number with a current trace number, the current trace number representing a number for use with a next transaction item in a series of transaction items.

15. The system of claim 13, further comprising:
a database storage for storing the transaction trace numbers assigned by said business layer with corresponding transaction data of the processed electronic funds transaction data.

16. The system of claim 15, wherein said business layer is operatively connected to said database storage, said business layer configured to perform data manipulation of the processed electronic funds transaction data according to (a) dishonored transaction items processing rules and (b) a tracking of dishonored transaction items via respective transaction trace numbers.

17. The system of claim 16, further comprising:
a database layer operatively connected to said business layer and said database storage, said database layer configured to store information in said database storage for tracking dishonored transaction items, the information for tracking dishonored transaction items including initial transaction trace numbers corresponding to trace numbers of transaction items prior to respective ones of the transaction items becoming dishonored transaction items and subsequent transaction trace numbers corresponding to trace numbers of dishonored transaction items prior to respective ones of the dishonored transaction items becoming subsequent dishonored transaction items.

18. The system of claim 15, still further comprising:
a scanned transaction retrieval module configured to separate Magnetic Ink Character Recognition (MICR) and transaction data detail from image detail of a scanned image of a paper financial transaction payment instrument, said scanned transaction retrieval (STR) module operatively connected to said business layer for transferring at least one of MICR data and transaction data to said business layer for processing corresponding electronic funds transaction data according to at least one of multiple independent rules based processing rules.

19. The system of claim 18, wherein at least one of multiple independent rules based processing rules includes a rule configured to determine a clearinghouse eligibility of the transaction item based upon at least one of the MICR data and transaction data of the transaction item.

20. The system of claim 19, wherein determining clearinghouse eligibility includes comparing a transaction amount of the transaction data with a character recognition component of the transaction amount obtained from the image detail of the transaction item.

21. The system of claim 18, further comprising:
an image storage operatively connected to said database storage, wherein said scanned transaction retrieval (STR) module is further configured to transfer the scanned image to said business layer, wherein said image storage is configured to store, in response to a storage request from said business layer, the scanned image of the paper financial transaction payment instrument, and wherein said database storage is further configured to store the corresponding MICR data and transaction data of the scanned image.

22. The system of claim 21, wherein said business layer is further configured to assign a transaction number to the scanned image of the paper financial transaction payment instrument relating to a transaction trace number of the corresponding transaction item, wherein the transaction trace number includes at least one of the following selected from the group consisting of a number based upon an algorithm, a sequence number based upon prior transaction processing, and a concatenation of a financial institution identification number with a current trace number, the current trace number representing a number in a sequence of transaction items.

23. The system of claim 13, still further comprising:
a scanned transaction retrieval module configured to separate Magnetic Ink Character Recognition (MICR) and transaction data detail from image detail of a scanned image of a paper financial transaction payment instrument, said scanned transaction retrieval module operatively connected to said business layer for transferring at least one of the MICR data and transaction data to said business layer for processing corresponding electronic funds transaction data according to at least one of multiple independent rules based processing rules including a rule configured to determine a clearinghouse eligibility of the transaction item based upon at least one of the MICR data and transaction data of the transaction item, wherein responsive to a determination of eligibility, said business layer is further operatively connected to said file transfer agent and configured to enable said file transfer agent to build the data file with eligible electronic funds transaction data and in response to building the data file, said file transfer agent routes the data file to at least one of the financial institution, the agent of a financial institution, and the electronic funds transaction clearinghouse network, for placement of the data file on the electronic funds transaction clearinghouse network,
further wherein responsive to a determination of ineligibility, said business layer processes the ineligible electronic funds transaction data according to at least one rule configured to process ineligible electronic funds transaction data, said business layer further being operatively connected to said file transfer agent and configured to enable said file transfer agent to build a second data file with ineligible electronic funds transaction data.

24. The system of claim 23, wherein at least one rule configured to process ineligible electronic funds transaction data includes a rule configured to route image detail of the ineligible electronic funds transaction data items to a second clearinghouse network for processing the ineligible electronic funds transaction data items as image items.

25. The system of claim 23, further comprising:
an image storage operatively connected to said database storage, and wherein said scanned transaction retrieval (STR) module is further configured to transfer the scanned image to said business layer,
wherein said image storage is configured to store, in response to a storage request from said business layer, the scanned image of the paper financial transaction payment instrument, further according to at least one of an eligibility and an ineligibility for electronic funds transaction clearinghouse network processing of a corresponding electronic funds transaction item, and further wherein said database layer is configured to store at least one of the (a) corresponding MICR and transaction data detail of the scanned image of eligible electronic funds transaction items in said database storage and (b) corresponding scanned image of the paper financial transaction payment instrument of ineligible electronic funds transaction items in said image storage.

26. The system of claim 25, wherein said business layer is further configured to assign a transaction number to the scanned image relating to a transaction trace number of the corresponding transaction item, wherein the transaction trace number is at least one of the following selected from the group consisting of a number based upon an algorithm, a sequence number based upon prior transaction processing, and a concatenation of a financial institution identification number with a current trace number, the current trace number representing a number in a sequence of transaction items.

27. The system of claim 13, wherein the custom configured business rule for dishonored item processing includes at least one of (a) provide notice of the dishonored item, (b) resubmit the dishonored item, (c) reroute the dishonored item, and (d) initiate according to the transaction data of the dishonored item at least one of the group consisting of reversing a recorded transaction, causing a reversal, and causing a reverse posting to at least one of an external system and an accounting database.

28. The system of claim 27, further wherein providing notice of the dishonored item includes providing a client with a custom configured notice of the dishonored item.

29. The system of claim 27, further wherein resubmitting the dishonored item includes a representment of the dishonored transaction data to the electronic funds transaction clearinghouse network as a new transaction item, wherein said business layer is further configured to determine an eligibility of the dishonored transaction data for representment, and, in response to a determination of eligibility, said business layer modifies the dishonored transaction data by replacing the transaction trace number of the dishonored transaction data with a second transaction trace number and storing the transaction trace number and the second transaction trace number in a dishonored trace audit table for tracking dishonored transaction items, wherein said file transfer agent builds the data file with at least one of the processed electronic funds transaction data and the modified dishonored transaction data, and in response to building the data file, transfers the data file to at least one of the financial institution, an agent of a financial institution, and an electronic funds transaction clearinghouse network for placement of the data file on the electronic funds transaction clearinghouse network.

30. The system of claim 27, further wherein rerouting the dishonored item includes routing the dishonored transaction data according to a custom configured rerouting rule.

31. The system of claim 27, further wherein initiating a reversal of the recorded transaction according to the transaction data of the dishonored item includes initiating a reversal of a corresponding transaction entry in at least one of a client general ledger and a client external system.

32. The system of claim 1, wherein said business layer is operatively connected to an interface for receiving electronic funds transaction data, the interface including a WEB interface configured for accepting electronic funds transaction originations, including at least one origination selected from the group consisting of Magnetic Ink Character Recognition (MICR) check scan, Point-of-Purchase, Mail order, Telephone order, Lockbox, and Accounts Receivable.

33. The system of claim 32, wherein the interface is further configured to support at least one of thick and thin clients.

34. The system of claim 6, wherein said interface is configured to operatively couple and integrate said system for rules based electronic funds transaction processing with a client system, the client system configured for accepting electronic funds transaction originations including at least one origination selected from the group consisting of Magnetic Ink Character Recognition (MICR) check scan, Point-of-Purchase, Mail order, Telephone order, Lockbox, and Accounts Receivable, and the client system further including at least one selected from the group consisting of an external database, point of sale database, remittance processing database, and remittance processing application, said interface further including a modular design configurable to requirements of the client system including at least one selected from the group consisting of MICR check scan, Point-of-Purchase, Mail order, Telephone order, Lockbox, Accounts Receivable, Internet commerce, and wireless device.

35. The system of claim 34, wherein said interface is further configured to support at least one of thick and thin clients.

36. The system of claim 34, further comprising:
a database layer, wherein said business layer is operatively connected to the database layer for performing an action in response to at least one selected from the group consisting of (a) a client source configured query, (b) a client source configured request and (c) a hosting system query.

37. A system for rules based electronic funds transaction processing comprising:
a business layer configured to receive electronic funds transaction data from a source and to process the electronic funds transaction data according to at least one of multiple independent rules based processing rules including at least one rule configured to process electronic funds clearinghouse network dishonored items, said business layer further configured to assign a transaction trace number to each transaction item of the processed electronic funds transaction data;
a file transfer agent operatively connected to said business layer for initiating a request to build a data file from the processed electronic funds transaction data, and in response to building the data file, said file transfer agent transfers the data file to at least one selected from the group consisting of a financial institution, an agent of a financial institution, and an electronic funds transaction clearinghouse network for placement of the data file on the electronic funds transaction clearinghouse network, wherein the data file includes a network ready data file having a format at least in accordance with requirements of the electronic funds transaction clearinghouse network, and wherein the transaction trace number is configured to enable tracking of a corresponding transaction item during dishonored items processing of a dishonored items data file retrieved from at least one of the financial institution, the agent of the financial institution, and the electronic funds transactions clearinghouse network, further wherein said business layer is configured to process the dishonored transaction items according to at least one of (a) a rules based dishonored item processing rule and (b) an electronic funds transaction clearinghouse network rule;
a database storage for storing the transaction trace numbers assigned by said business layer with corresponding transaction data of the processed electronic funds transaction data, wherein said business layer is further configured to perform data manipulation of the processed electronic funds transaction data according to (a) dishonored transaction items processing rules and (b) a tracking of dishonored transaction items via respective transaction trace numbers stored in said database storage; and
a database layer operatively connected to said database storage, said database layer configured to store information in said database storage for tracking dishonored transaction items, the information for tracking dishonored transaction items including initial transaction trace number corresponding to trace numbers of transaction items prior to respective ones of the transaction items becoming dishonored transaction items and subsequent transaction trace numbers corresponding to trace numbers of dishonored transaction items prior to respective ones of the dishonored transaction items becoming subsequent dishonored transaction items.

38. The system of claim 37, wherein said business layer is operatively connected to an interface for receiving electronic funds transaction data, the interface configured for accepting electronic funds transaction originations, including at least one origination selected from the group consisting of Magnetic Ink Character Recognition (MICR) check scan, Point-of-Purchase, Mail order, Telephone order, Lockbox, and Accounts Receivable.

39. A method for rules based electronic funds transaction processing comprising:
processing, via a business layer of a system configured to implement rules based electronic funds transaction processing, electronic funds transaction data received from a source according to at least one of multiple independent rules based processing rules including at least one rule configured to process electronic funds clearinghouse network dishonored items; and
initiating, via a file transfer agent of the system, a request to build a data file from the processed electronic funds transaction data, and in response to building the data file, transferring the data file to at least one of a financial institution, an agent of a financial institution, and an electronic funds transaction clearinghouse network for placement of the data file on an electronic funds transaction clearinghouse network, the data file including a network ready data file having a format at least in accordance with requirements of the electronic funds transaction clearinghouse network.

40. The method of claim 39, wherein at least one rule is configured to process network dishonored items on a case by case basis.

41. The method of claim 39, wherein the data file includes an ACH-Ready file and the electronic funds transaction clearinghouse network includes the ACH Network.

42. The method of claim 39, wherein the source includes a biller and wherein processing the electronics funds transaction data according to at least one of multiple independent rules based processing rules includes preventing submission of a transaction item of the electronic funds transaction data to the electronic funds transaction clearinghouse network if the transaction item contains a transaction amount for less than a transaction amount owed.

43. The method of claim 39, further comprising:
importing the electronic funds transaction data from the source via an interface.

44. The method of claim 43, wherein processing the electronic funds transaction data according to at least one of multiple independent rules based processing rules includes preventing a processing of the received electronic funds transaction data if at least one of source credentials of the source and interface credentials of the interface is invalid.

45. The method of claim 43, further comprising receiving a request from the source in connection with the electronic funds transaction data, processing the request and providing a response to the source via the interface.

46. The method of claim 39, further comprising:
performing, via the business layer and a database layer of the system, an action in response to at least one selected from the group consisting of (a) a client source configured query, (b) a client source configured request and (c) a hosting system query.

47. The method of claim 46, wherein the client source configured query includes a transaction history query and the client source configured request includes at least one of a transaction creation request and a recurring transaction modification request.

48. The method of claim 39, further comprising:
calling, via the business layer, a Positive/Negative database and processing the electronic funds transaction data as a function of Positive/Negative data in the Positive/Negative database.

49. The method of claim 39, further comprising:
retrieving, via the file transfer agent, dishonored item data from at least one of the financial institution, the agent of the financial institution, and the electronic funds transactions clearinghouse network; and
processing, via the business layer, the dishonored item data according to at least one selected from the group consisting of (a) a rules based processing rule and (b) an electronic funds financial transaction clearinghouse network rule.

50. The method of claim 39, further comprising:
prior to a transferring of the network ready data file to at least one of the financial institution, the agent of the financial institution, and the electronic funds transaction clearinghouse network, assigning, via the business layer, a transaction trace number to each transaction item of the processed electronic funds transaction data, the transaction trace number being configured to enable tracking of a corresponding transaction item during dishonored items processing of a dishonored items data file retrieved from at least one of the financial institution, the agent of the financial institution, and the electronic funds transaction clearinghouse network; and
processing the dishonored items according to at least one of a custom configured business rule and an electronic funds transactions clearinghouse network dishonored items rule.

51. The method of claim 50, wherein the transaction trace number includes at least one selected from the group consisting of a number based upon an algorithm, a sequence number based upon prior transaction processing, and a concatenation of a financial institution identification number with a current trace number, the current trace number representing a number for use with a next transaction item in a series of transaction items.

52. The method of claim 50, further comprising:
storing, via a database storage, the assigned transaction trace numbers with the corresponding transaction data of the processed electronic funds transaction data.

53. The method of claim 52, further comprising:
performing data manipulation of the processed electronic funds transaction data according to (a) dishonored items processing rules and (b) a tracking of dishonored transaction items via respective transaction trace numbers.

54. The method of claim 53, further comprising:
storing, via the database storage, information for tracking dishonored transaction items, the information for tracking dishonored transaction items including initial transaction trace numbers corresponding to trace numbers of transaction items prior to respective ones of the transaction items becoming dishonored transaction items and subsequent transaction trace numbers corresponding to trace numbers of dishonored transaction items prior to respective ones of the dishonored transaction items becoming subsequent dishonored transaction items.

55. The method of claim 52, still further comprising:
separating, via a scanned transaction retrieval module, (a) Magnetic Ink Character Recognition (MICR) and transaction data detail from (b) image detail of a scanned image of a paper financial transaction payment instrument; and
transferring the MICR and transaction data detail to the business layer for processing the electronic funds transaction data according to at least one of multiple independent rules based processing rules.

56. The method of claim 55, wherein at least one of multiple independent rules based processing rules includes a rule configured to determine a clearinghouse eligibility of a transaction item based upon at least one of MICR data and transaction data of the MICR and transaction data detail of the transaction item.

57. The method of claim 56, wherein determining the clearinghouse eligibility includes comparing a transaction amount of the transaction data with a character recognition component of the transaction amount obtained from the image detail of the transaction item.

58. The method of claim 57, further comprising:
storing the scanned image of the paper financial transaction payment instrument in an image storage coupled to the database storage, and storing the corresponding MICR and transaction data detail of the scanned image in the database storage.

59. The method of claim 50, wherein the custom configured business rule for dishonored items processing includes at least one of (a) provide notice of the dishonored item, (b) resubmit the dishonored item, (c) reroute the dishonored item, and (d) initiate according to the transaction data of the dishonored item at least one of reversing a recorded transaction according to the dishonored transaction data, causing a reversal, and causing a reverse posting to at least one of an external system and an accounting database.

60. The method of claim 59, further wherein providing notice of the dishonored item includes providing a client with a custom configured notice of the dishonored item.

61. The method of claim 59, further wherein resubmitting the dishonored item includes a representment of the dishonored transaction data to the electronic funds transaction clearinghouse network as a new transaction item in the data file, wherein said method further comprising:
determining an eligibility of the dishonored transaction data for representment, and, in response to a determination of eligibility, modifying the dishonored transaction data by replacing the transaction trace number of the dishonored transaction data with a second transaction trace number and storing the transaction trace number and the second transaction trace number in a dishonored trace audit table for tracking dishonored transaction items;
building the data file with at least one of the following selected from the group consisting of processed electronic funds transaction data and the modified dishonored transaction data; and
in response to building the data file, transferring the data file to at least one of the financial institution, the agent of a financial institution, and the electronic funds transaction clearinghouse network for placement of the data file on the electronic funds transaction clearinghouse network.

62. The method of claim 59, further wherein rerouting the dishonored item includes routing the dishonored transaction data according to a custom configured rerouting rule.

63. The method of claim 59, further wherein initiating a reversal of the recorded transaction according to the transaction data of the dishonored item includes initiating a reversal of a corresponding transaction entry in at least one of a client general ledger and a client external system.

64. The method of claim 39, further comprising:
configuring an interface to accept electronic funds transaction originations, including at least one origination selected from the group consisting of Magnetic Ink Character Recognition (MICR) check scan, Point-of-Purchase, Mail order, Telephone order, Lockbox, and Accounts Receivable; and
receiving the electronic funds transaction data from the source via the interface.

65. The method of claim 64, wherein configuring the interface includes providing support for at least one selected from the group consisting of thick clients and thin clients.

66. The method of claim 43, further comprising:
coupling and integrating the system with a client system via the interface, the client system configured to accept electronic funds transaction originations including at least one origination selected from the groups consisting of Magnetic Ink Character Recognition (MICR) check scan, Point-of-Purchase, Mail order, Telephone order, Lockbox, and Accounts Receivable, and the client system further including at least one of an external database, point of sale database, remittance processing database, and remittance processing application, and configuring a modular design of the interface to requirements of the client system including at least one selected from the group consisting of MICR check scan, Point-of-Purchase, Mail Order, Telephone order, Lockbox, Accounts receivable, Internet commerce, and wireless device.

67. The method of claim 66, wherein configuring the interface further includes providing support for at least one selected from the group consisting of thick clients and thin clients.

68. The method of claim 66, further comprising:
performing an action via the business layer in response to at least one selected from the group consisting of (a) a client configured query, (b) a client configured request and (c) a system query.

69. A computer program including instructions processable by a computer system for rules based electronic funds transaction processing comprising:
instructions for processing electronic funds transaction data received from a source according to at least one of multiple independent rules based processing rules including at least one rule configured to process electronic funds clearinghouse network dishonored items; and
instructions for initiating a request to build a data file from the processed electronic funds transaction data, and in response to building the data file, transferring the data file to at least one of a financial institution, an agent of a financial institution, and an electronic funds transaction clearinghouse network for placement of the data file on an electronic funds transaction clearinghouse network, the data file including a network ready data file having a format at least in accordance with requirements of the electronic funds transaction clearinghouse network.

70. The computer program of claim 69, wherein at least one rule is configured to process network dishonored items on a case by case basis.

71. The computer program of claim 69, wherein the data file includes an ACH-Ready file and the electronic funds transaction clearinghouse network includes the ACH Network.

72. The computer program of claim 69, wherein the source includes a biller and wherein processing the electronics funds transaction data according to at least one of multiple independent rules based processing rules includes preventing submission of a transaction item of the electronic funds transaction data to the electronic funds transaction clearinghouse network if the transaction item contains a transaction amount for less than a transaction amount owed.

73. The computer program of claim 69, further comprising:
instructions importing the electronic funds transaction data from the source via an interface.

74. The computer program of claim 73, wherein processing the electronic funds transaction data according to at least one of multiple independent rules based processing rules includes preventing a processing of the received electronic funds transaction data if at least one of source credentials of the source and interface credentials of the interface is invalid.

75. The computer program of claim 73, further comprising:
instructions for processing a request received from the source in connection with the electronic funds transaction data and providing a response to the source via the interface.

76. The computer program of claim 69, further comprising:
instructions for performing an action in response to at least one selected from the group consisting of (a) a client source configured query, (b) a client source configured request and (c) a hosting system query.

77. The computer program of claim 76, wherein the client source configured query includes a transaction history query and the client source configured request includes at least one of a transaction creation request and a recurring transaction modification request.

78. The computer program of claim 69, further comprising:
instructions for accessing a Positive/Negative database and processing the electronic funds transaction data as a function of Positive/Negative data in the Positive/Negative database.

79. The computer program of claim 69, further comprising:
instructions for retrieving dishonored item data from at least one of the financial institution, the agent of the financial institution, and the electronic funds transactions clearinghouse network; and
instructions for processing the dishonored item data according to at least one selected from the group consisting of (a) a rules based processing rule and (b) an electronic funds financial transaction clearinghouse network rule.

80. The computer program of claim 69, further comprising:
instructions for assigning a transaction trace number to each transaction item of the processed electronic funds transaction data, prior to a transferring of the network ready data file to at least one of the financial institution, the agent of the financial institution, and the electronic funds transaction clearinghouse network, wherein the transaction trace number is configured to enable tracking of a corresponding transaction item during dishonored items processing of a dishonored items data file retrieved from at least one of the financial institution, the agent of the financial institution, and the electronic funds transaction clearinghouse network; and
instructions for processing the dishonored items according to at least one of a custom configured business rule and an electronic funds transactions clearinghouse network dishonored items rule.

81. The computer program of claim 80, wherein the transaction trace number includes at least one selected from the group consisting of a number based upon an algorithm, a sequence number based upon prior transaction processing, and a concatenation of a financial institution identification number with a current trace number, the current trace number representing a number for use with a next transaction item in a series of transaction items.

82. The computer program of claim 80, further comprising:
instructions for storing the assigned transaction trace numbers with the corresponding transaction data of the processed electronic funds transaction data.

83. The computer program of claim 82, further comprising:
instructions for performing data manipulation of the processed electronic funds transaction data according to (a) dishonored items processing rules and (b) a tracking of dishonored transaction items via respective transaction trace numbers.

84. The computer program of claim 83, further comprising:
instructions for storing information for tracking dishonored transaction items, the information for tracking dishonored transaction items including initial transaction trace numbers corresponding to trace numbers of transaction items prior to respective ones of the transaction items becoming dishonored transaction items and subsequent transaction trace numbers corresponding to trace numbers of dishonored transaction items prior to respective ones of the dishonored transaction items becoming subsequent dishonored transaction items.

85. The computer program of claim 82, still further comprising:
instructions for separating (a) Magnetic Ink Character Recognition (MICR) and transaction data detail from (b) image detail of a scanned image of a paper financial transaction payment instrument; and
instructions for transferring the MICR and transaction data detail for processing the electronic funds transaction data according to at least one of multiple independent rules based processing rules.

86. The computer program of claim 85, wherein at least one of multiple independent rules based processing rules includes a rule configured to determine a clearinghouse eligibility of a transaction item based upon at least one of MICR data and transaction data of the MICR and transaction data detail of the transaction item.

87. The computer program of claim 86, wherein determining the clearinghouse eligibility includes comparing a transaction amount of the transaction data with a character recognition component of the transaction amount obtained from the image detail of the transaction item.

88. The computer program of claim 87, further comprising:
instructions for storing the scanned image of the paper financial transaction payment instrument, and storing the corresponding MICR and transaction data detail of the scanned image.

89. The computer program of claim 80, wherein the custom configured business rule for dishonored items processing includes at least one of (a) provide notice of the dishonored item, (b) resubmit the dishonored item, (c) reroute the dishonored item, and (d) initiate according to the transaction data of the dishonored item at least one of reversing a recorded transaction according to the dishonored transaction data, causing a reversal, and causing a reverse posting to at least one of an external system and an accounting database.

90. The computer program of claim 89, further wherein providing notice of the dishonored item includes providing a client with a custom configured notice of the dishonored item.

91. The computer program of claim 89, further wherein resubmitting the dishonored item includes a representment of the dishonored transaction data to the electronic funds transaction clearinghouse network as a new transaction item in the data file, wherein said computer program further comprising:
instructions for determining an eligibility of the dishonored transaction data for representment, and, in response to a determination of eligibility, modifying the dishonored transaction data by replacing the transaction trace number of the dishonored transaction data with a second transaction trace number and storing the transaction trace number and the second transaction trace number in a dishonored trace audit table for tracking dishonored transaction items, wherein building the data file further includes building the data file with at least one of the following selected from the group consisting of processed electronic funds transaction data and the modified dishonored transaction data.

92. The computer program of claim 89, further wherein rerouting the dishonored item includes routing the dishonored transaction data according to a custom configured rerouting rule.

93. The computer program of claim 89, further wherein initiating a reversal of the recorded transaction according to the transaction data of the dishonored item includes initiating a reversal of a corresponding transaction entry in at least one of a client general ledger and a client external system.

94. The computer program of claim 69, further comprising:
instructions for configuring an interface to accept electronic funds transaction originations, including at least one origination selected from the group consisting of Magnetic Ink Character Recognition (MICR) check scan, Point-of-Purchase, Mail order, Telephone order, Lockbox, and Accounts Receivable; and
instructions for receiving the electronic funds transaction data from the source via the interface.

95. The computer program of claim 94, wherein configuring the interface includes providing support for at least one selected from the group consisting of thick clients and thin clients.

96. The computer program of claim 73, further comprising:
instructions for coupling and integrating the computer system with a client system via the interface, the client system configured to accept electronic funds transaction originations including at least one origination selected from the groups consisting of Magnetic Ink Character Recognition (MICR) check scan, Point-of-Purchase, Mail order, Telephone order, Lockbox, and Accounts Receivable, and the client system further including at least one of an external database, point of sale database, remittance processing database, and remittance processing application, and instructions for configuring a modular design of the interface to requirements of the client system including at least one selected from the group consisting of MICR check scan, Point-of-Purchase, Mail Order, Telephone order, Lockbox, Accounts receivable, Internet commerce, and wireless device.

97. The computer program of claim 96, wherein configuring the interface further includes providing support for at least one selected from the group consisting of thick clients and thin clients.

98. The computer program of claim 96, further comprising:
instructions for performing an action in response to at least one selected from the group consisting of (a) a client configured query, (b) a client configured request and (c) a system query.
